(19) United States
(12) Patent Application Publication
(10) Pub. No.: US 2026/0368486 A1
(43) Pub. Date: Nov. 19, 2026

(54) ADAPTIVE TENSOR PARALLELISM

(71) Applicant: QUALCOMM Incorporated, San Diego, CA (US)

(72) Inventors: Qi XUE, San Diego, CA (US); Abhijit NAVALEKAR, Westford, MA (US)

(21) Appl. No.: 19/211,098

(22) Filed: May 16, 2025

(51) Int. Cl. G06N 3/045; G06N 3/0464

(52) U.S. Cl. CPC G06N 3/045; G06N 3/0464

(57) ABSTRACT

Systems and techniques are described herein for machine learning processing. For example, a computing device can determine to process an input embedding to generate key-value pairs using a pipeline parallelization mode of an apparatus; process the input embedding to generate the key-value pairs based on the pipeline parallelization mode of the apparatus; determine to decode the key-value pairs using a tensor parallelization mode of the apparatus; and generate an output based on the tensor parallelization mode of the apparatus.

### FIELD

The present disclosure generally relates to machine learning system processing using tensor parallelism. For example, aspects of the present disclosure relate to systems and techniques for adaptive tensor parallelism.

### BACKGROUND

Machine learning systems operating on portable electronics (e.g., smartphones, tablets, laptops, etc.) generally are scaled down in size to accommodate for resource constraints of portable electronics. For example, power consumption, memory constraints, and processing power constraints of portable electronics can limit the size and complexity of machine earning systems which can be deployed to portable electronics. In some examples, machine learning systems can accommodate the limitations of portable electronic devices by executing the machine learning system to external computing resources (e.g., computing resources external to the portable electronic device). The external computing resources can be cloud service infrastructure, such as servers, which can perform resource intensive tasks not able to be effectively performed on the portable electronics (e.g., due to the constraints of the portable electronics). In some examples, hybrid approaches can be performed, where portions of a machine learning system are performed on portable electronics and other portions of the machine learning system are performed on the cloud service infrastructure.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for machine learning processing is provided. The apparatus includes at least one memory and at least one processor coupled to the at least one memory and configured to: determine to process an input embedding to generate key-value pairs using a pipeline parallelization mode of the apparatus; process the input embedding to generate the key-value pairs based on the pipeline parallelization mode of the apparatus; determine to decode the key-value pairs using a tensor parallelization mode of the apparatus; and generate an output based on the tensor parallelization mode of the apparatus.

In some aspects, a method for machine learning processing is provided. The method includes: determining to process an input embedding to generate key-value pairs using a pipeline parallelization mode of an apparatus; processing the input embedding to generate the key-value pairs based on the pipeline parallelization mode of the apparatus; determining to decode the key-value pairs using a tensor parallelization mode of the apparatus; and generating an output based on the tensor parallelization mode of the apparatus.

In some aspects, a non-transitory computer-readable medium is provided having stored thereon instructions that, when executed by at least one processor, cause the at least one processor to: determine to process an input embedding to generate key-value pairs using a pipeline parallelization mode of the computing device; process the input embedding to generate the key-value pairs based on the pipeline parallelization mode of the computing device; determine to decode the key-value pairs using a tensor parallelization mode of the computing device; and generate an output based on the tensor parallelization mode of the computing device.

In some aspects, an apparatus for machine learning processing is provided. The apparatus includes: means for determining to process an input embedding to generate key-value pairs using a pipeline parallelization mode of an apparatus; processing the input embedding to generate the key-value pairs based on the pipeline parallelization mode of the apparatus; means for determining to decode the key-value pairs using a tensor parallelization mode of the apparatus; and means for generating an output based on the tensor parallelization mode of the apparatus.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates an example implementation of a system-on-a-chip (SoC), in accordance with aspects of the present disclosure.

FIG. 2 is a block diagram illustrating an example of partitioning a machine learning network for tensor parallelization, in accordance with aspects of the present disclosure.

FIG. 3A is a block diagram illustrating machine learning network input processing in a machine learning network distribution across computing devices, in accordance with aspects of the present disclosure.

FIG. 3B is a block diagram illustrating machine learning network input chunking and chunk parallel processing in a machine learning network distribution across computing devices, in accordance with aspects of the present disclosure.

FIG. 4 is a block diagram illustrating an example of tensor parallelization of a machine learning network, in accordance with aspects of the present disclosure.

FIG. 5 is a block diagram illustrating an example look up table (LUT), in accordance with aspects of the present disclosure.

FIG. 6 is a flow diagram illustrating an example process for determining a whether to use tensor parallelization or pipeline parallelization, in accordance with aspects of the present disclosure.

FIG. 7 is a flow diagram illustrating another example process for determining a whether to use tensor parallelization or pipeline parallelization, in accordance with aspects of the present disclosure.

FIG. 8 is a block diagram illustrating an example of performing pipeline parallelization and tensor parallelization, in accordance with aspects of the present disclosure.

FIG. 9 is a flow diagram illustrating an example process of machine learning processing, in accordance with aspects of the present disclosure.

FIG. 10 is a flow diagram illustrating another example process of machine learning processing, in accordance with aspects of the present disclosure.

FIG. 11 is a block diagram illustrating an example neural network, in accordance with aspects of the present disclosure.

FIG. 12 is a block diagram illustrating an example convolutional neural network, in accordance with aspects of the present disclosure.

FIG. 13 is a block diagram of an example transformer in accordance with aspects of the disclosure.

FIG. 14 is a block diagram illustrating example computing device architecture of an example computing device which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

As previously mentioned, machine learning systems operating on portable electronics (e.g., smartphones, tablets, laptops, etc.) generally are scaled down in size to accommodate for resource constraints of portable electronics. For example, power consumption, memory constraints, and processing power constraints of portable electronics can limit the size and complexity of machine learning systems which can be deployed to portable electronics. In some examples, machine learning systems can accommodate the limitations of portable electronic devices by executing the machine learning system to external computing resources (e.g., computing resources external to the portable electronic device). The external computing resources can be cloud service infrastructure, such as servers, which can perform resource intensive tasks not able to be effectively performed on the portable electronics (e.g., due to the constraints of the portable electronics). In some examples, hybrid approaches can be performed, where portions of a machine learning system are performed on portable electronics and other portions of the machine learning system are performed on the cloud service infrastructure.

Tensor parallelization is a technique for distributing processing of a machine learning network across a plurality of processors or devices by separating tensors of the machine learning network (e.g., weights and activations of the machine learning network) into portions of tensors. Processing the tensors of the machine learning network using multiple devices in parallel can reduce computational resource usage of individual devices allowing for deployment of machine learning networks which may otherwise be unable to run on an individual device. Tensor parallelization can also provide shorter processing times by reducing the amount of data processed by each of the individual devices. Processing the tensors of the machine learning network in parallel can allow for faster processing speeds by reducing the amount or size of tensors processed by individual devices.

Machine learning network inferences (such as large language models inferences) can include multiple stages such as a prefill stage and a decode stage. Tensor parallelism can be used in the prefill stage and the decode stage. In one example of the prefill stage, a device or apparatus can generate a token index associated with a layer of a machine learning network and determine rows of an embedding representation of the layer (e.g., weights, parameters, tensors, etc.) corresponding to the token index. The prefill stage can include dividing the embedding into portions and distributing the portions to one or more additional devices.

Tensor parallelization can be used in addition to other parallelism techniques, such as pipeline parallelism. Pipeline parallelism is a technique separating a machine learning network into sequences of operations and performing sequences of operations on various devices. Devices performing pipeline parallelism of a machine learning network can process a subset of layers of the machine learning network using the devices. Additional subsets can be processed using additional devices. In some examples, pipeline parallelization can include using portions of a machine learning network, or portions of a layer of the machine learning network, to process an input to generate key-value pairs of the machine learning network.

Systems, apparatuses, electronic devices, methods (also referred to as processes), and computer-readable media (collectively referred to herein as “systems and techniques”) are described herein for machine learning system processing. In some aspects, the systems and techniques can include tensor parallelization and pipeline parallelization of a machine learning network to process portions of a machine learning network (or machine learning system) using a plurality of devices. The plurality of devices can include multiple portable electronic devices (e.g., smartphones, laptops, tablets, etc.), a plurality of edge devices, a plurality of computing cores of a processor of an apparatus, multiple servers, etc. In some examples, the machine learning network can include a neural network, a transformer, a language model (e.g., a large language model LLM), etc.

In some aspects, the systems and techniques can include tensor parallelization techniques to reduce idle times of devices executing a machine learning network. Tensor parallelization can include partitioning the machine learning network (e.g., individual layers of a machine learning network) into a plurality of portions. For example, individual layers of the machine learning network can be divided into portions. In such an example, a first portion of the machine learning network can include weights or parameters associated with the first portion of the machine learning network. A second portion of the machine learning network can include weights or parameters associated with the second portion of the machine learning network, the weights or parameters of the second portion of the machine learning network being different weights or parameters of the machine learning network.

In such an example, the tensor parallelization can include providing the portions of the machine learning network (e.g., portions of individual layers of the machine learning network such as a portion of an attention layer) to one or more devices, also referred to as a plurality of devices or additional devices. For example, a first device can receive a first portion of the machine learning network (e.g., a first portion of a layer of the machine learning network), a second device can receive a second portion of the machine learning network (e.g., a second portion of the layer of the machine learning network), etc. In further examples, each device can receive the machine learning network and load into memory (e.g., into dynamic random access memory of the device or of a processor of the device) a portion of the machine learning network corresponding to the machine learning network. In some examples, the tensor parallelization can be performed using a plurality of computing cores of a processor or a plurality of processors of a device.

In some aspects, the systems and techniques can include processing an input embedding using a portion of a layer of the machine learning network (e.g., a first portion of a first layer of the machine learning network). For example, the input embedding can be a representation (e.g., matrix, vector, array) of an input to the machine learning network or a representation of activations of layers of the machine learning network (e.g., output activations of a layer of the machine learning network). The portion of the layer of the machine learning network can correspond to a first device (or apparatus).

Additional portions of the layer (e.g., a second portion of the first layer of the machine learning network) can be used to process the input embedding to generate additional output embeddings. In such an example, the additional portions of the layer can be processed using additional devices. For example, the second portion of the first layer can be processed using a second device, a third portion of the first layer can be processed using a third device, etc. In some examples, the layer of the machine learning network can be an attention layer of the machine learning network (e.g., a self-attention layer, a cross-attention layer, etc.), a convolutional layer, a portion of a feedforward network, etc.

In some examples, the input embedding processed using the various portions of layers of the machine learning network can be the same input embedding for each of the various portions of the layers. For example, devices performing tensor parallelization can each receive an instance (e.g., a copy) of the input embedding. In such an example, the portion of the layers of the machine learning network corresponding to a device can be used to process the input embedding to generate an output embedding. In such an example, the output embedding generated by an individual device from the plurality of devices can represent a portion of a combined output embedding representing an output embedding of the entire layer of the machine learning network.

In some aspects, the systems and techniques can include partitioning the machine learning network into portions based on specifications of the one or more devices. For example, the one or more devices can include memory constraints, processing power constraints, battery constraints, latency constraints (e.g., poor connection to a server, or to the one or more additional devices). In such an example, the systems and techniques can include partitioning the machine learning network (e.g., weights and parameters of layers of the machine learning network) into portions corresponding to the specifications of each device from the one or more devices. In such an example, the size of the portions can be apportioned such that each device of the one or more devices can process a respective portion in a substantially equivalent period of time as the other devices from the one or more devices. For example, a device with more memory or more processing power can include more weights and parameters (e.g., a bigger portion of the layer) than a device with less memory or less processing power. In such an example, the number of weights, parameters, and tensors provided to the one or more devices can be proportional to the specifications of the one or more devices such that the compute time and communication time for each device is substantially equivalent.

In some examples, the one or more additional devices can be provisioned to transmit or broadcast the results (e.g., output embeddings) of processing the input embedding using a portion of a layer (or portion of a plurality of layers) of the machine learning network. For example, some operations or tasks can require an entire output embedding (e.g., a combined output embedding including each of the output embeddings of each portion of a layer of the machine learning network). For example, a second layer of the machine learning network can use the output embedding of a first layer as an input. In such an example, the combined output embedding of the first layer of the machine learning network can be determined before proceeding to using the second layer of the machine learning network to process the combined output embedding using the second layer.

In such an example, each device of the one or more devices can provide respective output embeddings associated with the portion of the layer executed on the respective device to a device from the one or more devices to generate the combined output embedding. In some examples, the combined output embedding can be an embedding representation of the output embeddings from the one or more devices. For example, the output embeddings associated with portions of a layer of the machine learning network can represent a portion of a matrix or vector corresponding to the weights or parameters of the machine learning network used to process the input embedding. In such an example, the combined output embedding can be a matrix or vector combining the output embeddings of the one or more devices.

In some aspects, the systems and techniques can include transmitting the output embeddings to a root device from the one or more devices. The root device can be a device from the one or more devices which can combine the output embeddings to generate the combined output embedding. In some examples, the root device can be predetermined or provisioned. In further examples, the root device can change during the tensor parallelization. For example, the root device can be the last device from the one or more devices to receive a combined output embedding associated with a previous layer of the machine learning network.

In some aspects, the systems and techniques can include transmitting or broadcasting the output embeddings to a root device using a unicast or multicast transmission. In further examples, the root device can transmit or broadcast the combined output embedding using a unicast or multicast transmission. For example, the root device can transmit the combined output embedding in sequential order to devices from the one or more devices in a predetermined sequence. In further examples, the sequential order of the transmission can be in order based on the order the devices provide an output embedding to the root device, or in a reverse sequential order of the order the devices provide the output embedding to the root device.

In some examples, the one or more devices can include multiple root devices. For example, devices from the one or more devices can be a root device (e.g., the device receiving output embeddings associated with portions of layers from the one or more additional devices to generate a combined output embedding) when processing an input embedding using a first layer, and another device can be the root device when processing an input embedding using a second layer. In such an example, devices which are root devices can alternate between the other devices to be the device to generate the combined output embedding. In such an example, the devices can alternate between being the root device to reduce a wait time of devices processing the combined output using a respective portion of a layer of the machine learning network.

In some aspects, the systems and techniques can include determining when to use tensor parallelization, pipeline parallelization, or both parallelization techniques to process an input embedding. For example, the systems and techniques can include using pipeline parallelization to process an input embedding during a prefill stage (or prefill phase) and using tensor parallelization to process a result of the prefill stage to generate output. In such an example, the prefill stage can be an initial stage during inference in which an input to the machine learning network (e.g., a user prompt) is processed to generate tokenized representations of the input. In such an example, layers of the machine learning network (e.g., attention layers) can generate and store key-value (KV) pairs. The KV pairs can be stored in a cache of a device or processor. The machine learning network can use the cached KV pairs to reuse when generating additional tokens.

In some aspects, the systems and techniques can include a decode stage (or decode phase). In such an example, the decode stage can follow the prefill stage. The decode stage can be a stage of the systems and techniques where the machine learning network generates tokens. In such an example, the machine learning network can use the KV pairs stored in the cache to generate tokens. For example, the KV pairs stored in the cache can be used to avoid recomputing attention across an entire input to the machine learning network. In some examples, the KV cache transfer can occur in parallel to computations (e.g., a subsequent output/KV can be computed concurrent with transferring a previous KV cache).

In some aspects, the systems and techniques can include determining whether to transition a device, system, apparatus, process, etc. to a tensor parallelization mode to perform tensor parallelization or a pipeline parallelization mode to perform pipeline parallelization. For example, the systems and techniques can include determining whether to transition to the tensor parallelization mode based on token latency and decode rates of a machine learning network. In such an example, token latency can refer to a period time for a machine learning network to process or generate a token. For example, the token latency can include a period of time to generate a first token.

In some examples, the token latency can be based on various characteristics of a machine learning network and specifications of devices to be used during tensor parallelization or pipeline parallelization. For example, token latency can be based on a data link speed between devices, an input prompt size (e.g., size of an input user prompt to the machine learning network, or size of an input embedding), the number of devices from the one or more devices to be used during tensor parallelization and pipeline parallelization, an expected output length or size (e.g., expected size of an output embedding or KV pair size), stage of the machine learning network (e.g., during prefill stage or during decode stage), and the type of parallelization (e.g., a tensor parallelization mode or pipeline parallelization mode).

Decode rate can refer to a rate (e.g., speed) at which the machine learning network can generate tokens during the decode stage. The decode rate can indicate efficiency of a machine learning network in generate tokens after the prefill stage using KV pair caches. The decode rate can be based on various characteristics of the machine learning network and specifications of devices to be used during tensor parallelization or pipeline parallelization. For example, the decode rate can be based on a machine learning network size, the number of devices being used for parallelization, the type of parallelization (e.g., a tensor parallelization mode or pipeline parallelization mode), number of tokens previously generated, etc.

In some aspects, the systems and techniques can include determining whether to use tensor parallelization (e.g., using a tensor parallelization mode of a device or plurality of devices) or pipeline parallelization (e.g., using a pipeline parallelization mode of a device or plurality of devices). In such an example, the determination can be based on the token latency and decode rate. For example, the systems and techniques can include determining a number of devices to be used during a stage of operation (e.g., prefill stage or decode stage). In such an example, the token latency and decode rate can be computed or estimated based on characteristics of the devices, inputs, and the machine learning network for pipeline parallelization and tensor parallelization.

In some examples, the token latency can be an end-to-end token latency. In such an example, the end-to-end token latency can represent a token latency associated with a time period for processing inputs to a machine learning network and generating an output. The end-to-end token latency (tₑ₂ₑ) can be represented as tₑ₂ₑ=t_{ttft}+t_{decode}. In such an example, t_{ttft} can represent a time period to generate a first token (e.g., during a prefill stage) from the input and t_{decode} can represent a time to generate an output of the machine learning network. Assuming tₑ₂ₑ is distributive and t_{ttft} and t_{decode} are independent, min(tₑ₂ₑ)=min(t_{ttft})+min(t_{decode}). During pipeline parallelism, t_{ttft} can be represented as t_{ttft}=(D^{f}ₚ−1+Bₚ)*P^{f}ₚ+t^{f}ₚ*D^{f}ₚ where D^{f}ₚ is the number of devices in prefill phase, Bₚ is a number of portions (ceil(prompt_len/p_portion_size)), t is a transmit latency from one node (or device) to another for prefill payload, P^{f}ₚ is a processing time for single prefill portion (given by the time it takes for memory [M (N)] and compute operations [C (N,p_portion_size)] for the model i.e. P^{f}ₚ=M (N)+C (N,portion_size)).

The t_{decode} for pipeline parallelization can be represented as t_{decode}=output_len*((D^{d}ₚ−1+B_{d})*P^{d}ₚ+t^{d}ₚ*D^{d}ₚ)/A where D^{d}ₚ is the number of devices in decode phase, B_{d} is number of portions (ceil(draft_size/d_portion_size)), t_{d} is a transmit latency from one node (or device) to another, P^{d}ₚ is a processing time for single decode portion, and A is a token acceptance rate.

The t_{ttft} for tensor parallelization can be represented as t_{ttft}=P^{f}ₜ/D^{f}ₜ+t^{f}ₜ*(D^{f}ₜ−1) where D^{f}ₜ represents the number of devices in prefill phase, t is a transmit latency from one node to another for expected payload for all layers, P^{f}ₜ is a processing time for single prefill portion (given by the time it takes for memory [M (N)] and compute operations [C (N, p_portion_size)] for the model i.e. P=M (N)+C (N, portion_size)).

The t_{decode} for tensor parallelization can be represented as t_{decode}=output_len*((P^{d}ₜ/D^{d}ₜ)+t^{d}ₜ*(D^{d}ₜ−1))/A where D^{d}ₜ represents the number of devices in decode phase, t^{d}ₜ is a transmit latency from one node (or device) to another for expected payload for layers of the machine learning network, P^{d}ₜ is a processing time for single decode portion, A is a token acceptance rate.

For example, the systems and techniques can include determining to use pipeline parallelization or tensor parallelization based on the token latency during the prefill stage and determining to use pipeline parallelization or tensor parallelization based on a decode rate during the decode stage. In further examples, the systems and techniques can include using a look up table (LUT) of token latency values and decode rates. In such an example, the systems and techniques can include selecting between a pipeline parallelization mode and a tensor parallelization mode during a prefill stage based on the token latency (e.g., time to first token latency or end to end token latency being lower indicating a lower token latency) and selecting between a pipeline parallelization mode and a tensor parallelization mode during the decode stage.

In some aspects, the systems and techniques can include determining to process an input to the machine learning network to generate KV pairs using the pipeline parallelization mode of a device or apparatus (e.g., based on token latency). The systems and techniques can include processing the input to generate the KV pairs using pipeline parallelization (e.g., based on the pipeline parallelization mode of the device or apparatus). The systems and techniques can include determining (e.g., based on the decode rate being higher for tensor parallelization than pipeline parallelization) to decode the KV pairs using tensor parallelization (e.g., based on the tensor parallelization mode of the device or apparatus). In further examples, the systems and techniques can include generating output using tensor parallelization (e.g., based on a tensor parallelization mode of the device or apparatus).

In some aspects, the number of devices used to perform pipeline parallelization and tensor parallelization can change based on the stage of the machine learning network (e.g., from prefill stage to decode stage). In one such example, four devices can be used for pipeline parallelization during a prefill stage and two devices can be used for tensor parallelization during a decode stage. In such an example, the devices used for tensor parallelization can be different devices from the devices used during the prefill stage. In further examples, the device used for tensor parallelization can be a subset of devices from the devices used during the decode stage. In some aspects, the systems and techniques can include transferring the KV pairs from various caches of devices. For example, the systems and techniques can include transferring or transmitting KV pairs stored in a first cache of a device to a second cache of another device. For example, the first cache can be associated with a layer of the machine learning network during a prefill stage using a pipeline parallelization mode to a second cache associated with a second layer of the machine learning network during a decode stage using a tensor parallelization mode.

Various aspects of the present disclosure will be described with respect to the figures.

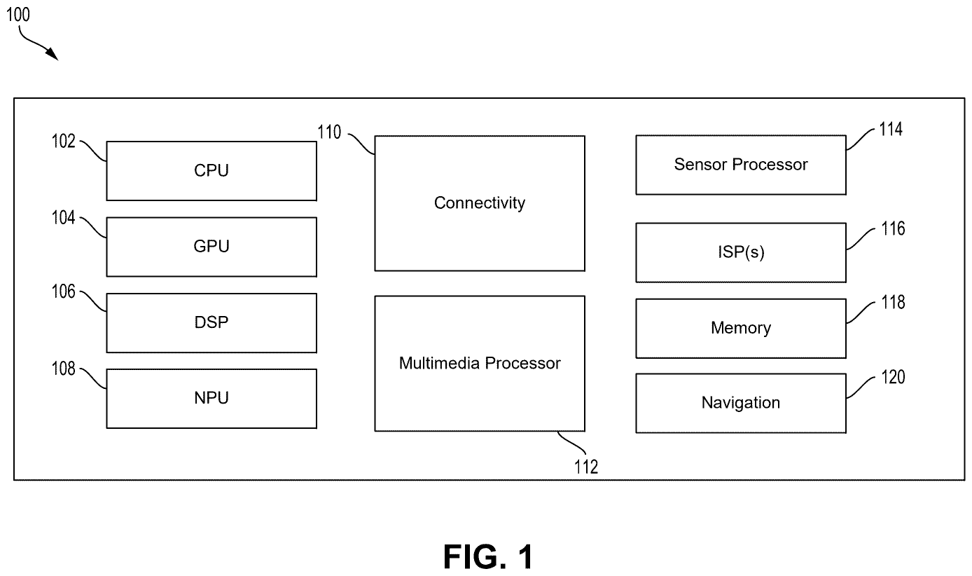

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize audio signals. In one implementation, the NPU is implemented in the CPU 102, DSP 106, and/or GPU 104. The SOC 100 may also include one or more sensors 114 such as but not limited to one or more microphones, image signal processors (ISPs) 110, and/or storage 120.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 and/or components thereof may be configured to generate explanations for actions performed (e.g., to be performed, predicted to be performed, etc.) by a machine learning model. The explanations can be one or more of a text-based description, set of instructions to perform a sub-task or task, etc. according to aspects of the present disclosure discussed herein. The SOC can be used to operate various machine learning models for image processing, text processing, feature extraction, signal controls generation, etc. For example, SOC 100 and/or components thereof may be configured to perform processing techniques such as but not limited to: segment shifting, shuffle correlation, gain shifting, segment masking, and additional processing techniques. SOC 100 can be part of a computing device or multiple computing devices. In some examples, SOC 100 can be part of an electronic device (or devices) such as an audio recording device, camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 106, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 106, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 106, the NPU 108, the connectivity block 110, the multimedia processor 112, the one or more sensors 114, the ISPs 116, the memory block 118 and/or the storage 120 can be part of two or more separate computing devices.

Machine learning (ML) can be considered a subset of artificial intelligence (AI). ML systems can include algorithms and statistical models that computer systems can use to perform various tasks by relying on patterns and inference, without the use of explicit instructions. An example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of audio can benefit from first learning to recognize individual spoken words, instruments in music, etc. These features may be combined at higher layers in different ways to recognize sounds such as speech, instruments, wind noise, etc.

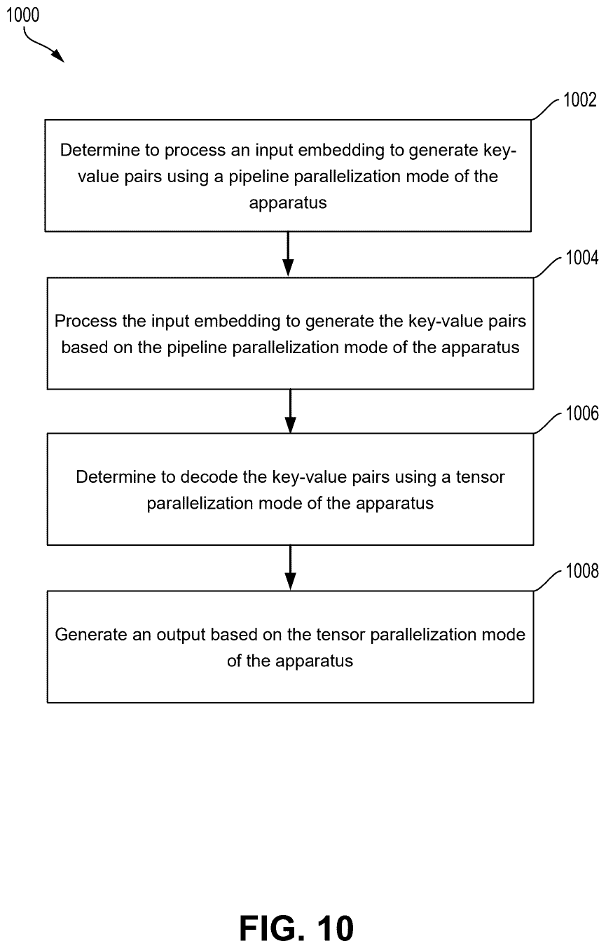

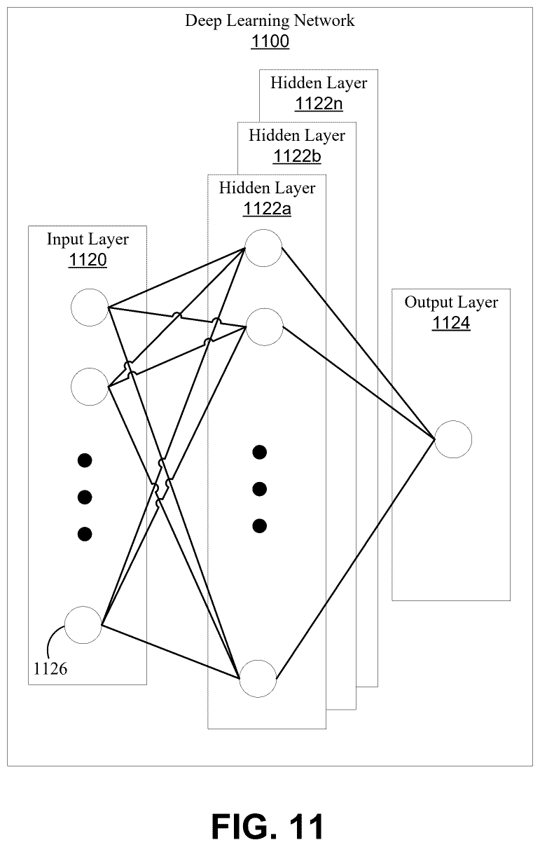

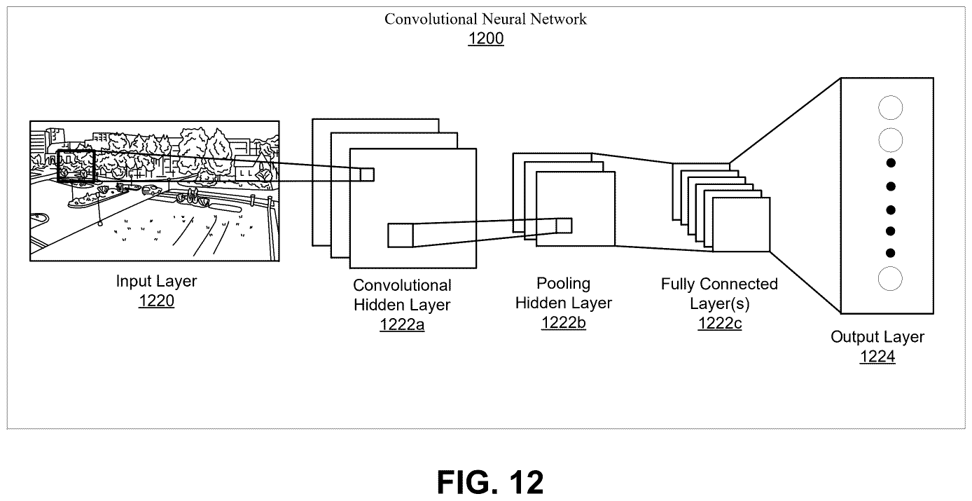

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. Further description of machine learning model architecture is provided in the description of FIG. 10, FIG. 11, and FIG. 12.

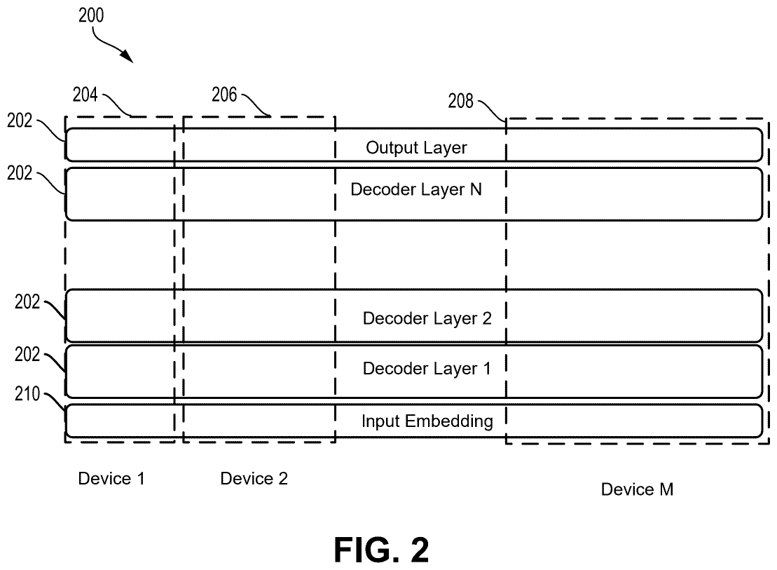

The SOC 100 of FIG. 1 can be used to perform the various systems and techniques described in the descriptions of FIG. 2-FIG. 9. For example, the SOC 100 can be used to perform operations of the machine learning networks and systems described in the description of FIG. 2-FIG. 9 tensor parallelization and pipeline parallelization.

FIG. 2 is a block diagram illustrating an example of partitioning a machine learning network 200 for tensor parallelization. The machine learning network 200 includes a plurality of layers 202. For example, the plurality of layers 202 can include decoder layers, output layers, convolutional layers, etc. The plurality of layers can be partitioned into portions (e.g., portion 204, portion 206, portion 208) based on a number of devices used during tensor parallelization.

For example, the machine learning network 200 is illustrated as being divided into M portions based on the machine learning network 200 using M number of devices for tensor parallelization. Tensor parallelization can include partitioning the machine learning network 200 into portions (e.g., the layers of the machine learning network 200) into portions to process an input embedding 210 synchronously across multiple devices, nodes, processors, or computing cores of a processor.

For example, the devices used to perform tensor parallelization can include memory constraints, processing power constraints, battery constraints, latency constraints (e.g., poor connection to a server, or to additional devices). In such an example, the size of portions (e.g., the portion 204, the portion 206, and the portion 208) of the plurality of layers 202 can be partitioned into portions corresponding to the specifications of each device from the devices performing tensor parallelization. In such an example, the size of the portions can be apportioned such that each device can process a respective portion in substantially the same amount of time other devices used to perform the tensor parallelization. In such an example, a device with more processing power can include a larger portion of the layer (e.g., more weights, parameters, and tensors) than a device with less processing power. The number of weights, parameters, and tensors provided to the devices can be proportional to the specifications or capabilities of the devices such that the compute time and communication time for each device is substantially the same in length.

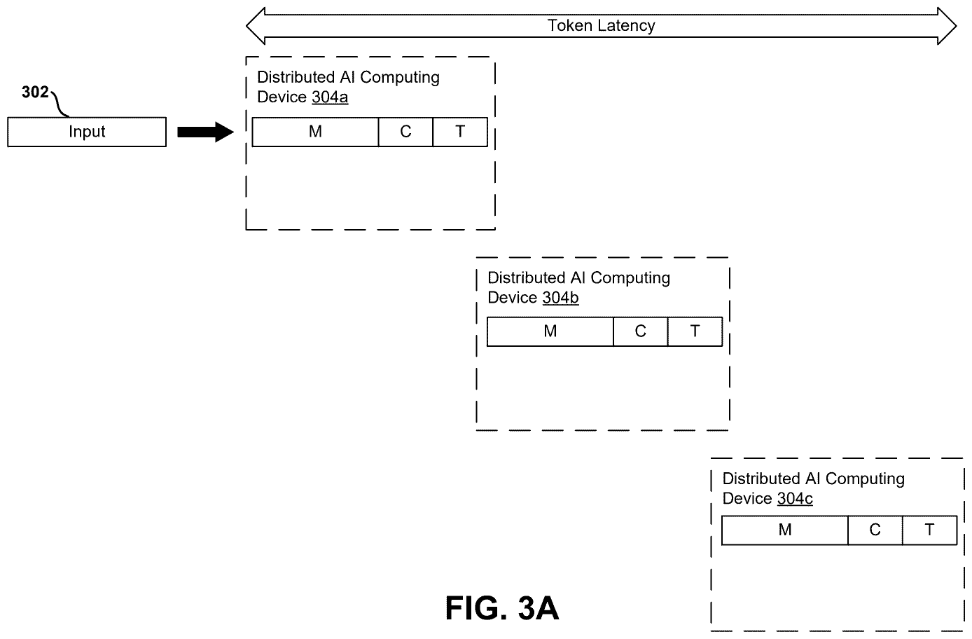

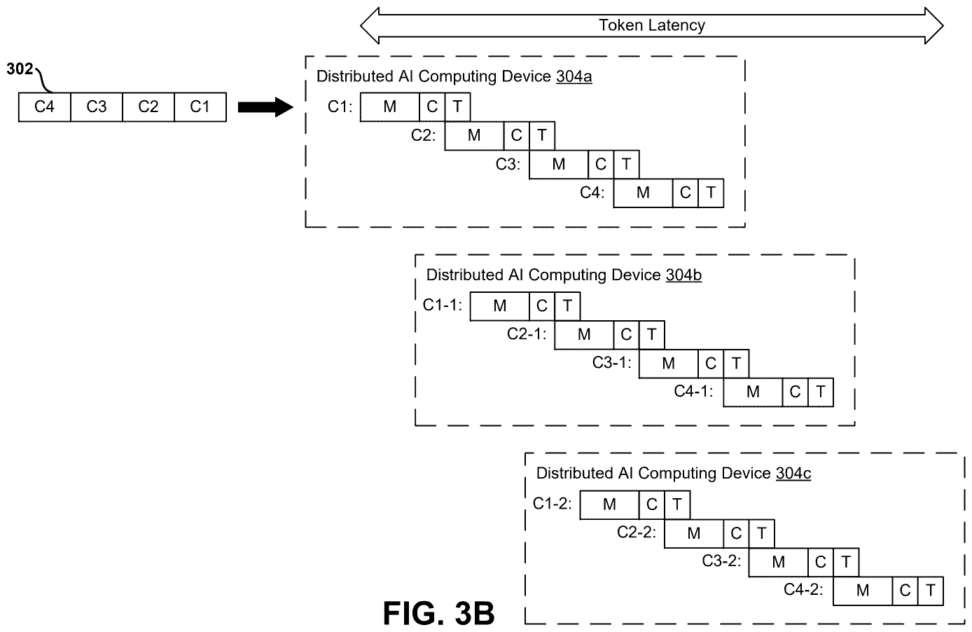

FIG. 3A is a block diagram illustrating machine learning network input processing in a machine learning network distribution across computing devices 304a, 304b, 304c of a distributed AI computing system in accordance with some aspects. With reference to FIG. 2 to FIG. 3B, an input 302 may be input in batches to a distributed machine learning network distributed across the computing devices 304a, 304b, 304c, and processed, generating intermediary chunks. Processing of the input and the intermediary chunks may take time, including a memory I/O latency time (M), a compute time (C), and a time for transmission between computing devices 304a, 304b, 304c (T).

The input may be processed by the distributed AI computing device 304a implementing an allocated portion of the distributed machine learning network including one or more input layers and/or one or more decoder layers. Processing the input 302 may generate intermediary chunks. The memory and compute operations for processing the input may be implemented serially. The transmission operations for transmitting the intermediary chunks may occur serially with the memory and/or compute operations for processing the input.

The intermediary chunks may be processed by a distributed AI computing device 304b implementing an allocated portion of the distributed machine learning network including one or more decoder layers. Processing the intermediary chunks may generate further intermediary chunks. The memory and compute operations for processing the intermediary chunks may be implemented serially. The transmission operations for transmitting the intermediary chunks may occur serially with the memory and/or compute operations for processing the intermediary chunks. Memory, compute, and transmission operations implemented by the distributed AI computing device 304b may be implemented serially with memory, compute, and transmission operations implemented by the distributed AI computing device 304a.

The intermediary chunks may be processed by a distributed AI computing device 304c implementing an allocated portion of the distributed machine learning network including one or more decoder layers. Processing the intermediary chunks may generate further intermediary chunks (not shown). The memory and compute operations for processing the intermediary chunks may be implemented serially. The transmission operations for transmitting the further intermediary chunks may occur serially with the memory and/or compute operations for processing the intermediary chunks. Memory, compute, and transmission operations implemented by the distributed AI computing device 304c may be implemented serially with memory, compute, and transmission operations implemented by the distributed AI computing device 304b.

FIG. 3B is a block diagram illustrating machine learning network input chunking and chunk parallel processing in a machine learning network distribution across computing devices 304a, 304b, 304c of a distributed AI computing system in accordance with some aspects. An input 302 may be divided into input chunks (e.g., C1, C2, C3, C4) of an input chunk size. The input chunks may be input in batches to a distributed machine learning network distributed across the computing devices 304a, 304b, 304c, and processed, generating intermediary chunks (e.g., C1-1, C2-1, C3-1, C4-1, C1-2, C2-2, C3-2, C4-2). Processing of input and intermediary chunks may take time, including a memory I/O latency time (M), a compute time (C), and a time for transmission between computing devices 304a, 304b, 304c (T).

The input chunks may be processed by the distributed AI computing device 304a implementing an allocated portion of the distributed machine learning network including one or more input layers and/or one or more decoder layers. Processing the input chunks may generate intermediary chunks (e.g., C1-1, C2-1, C3-1, C4-1). The memory and compute operations for processing the input chunks may be implemented serially. The transmission operations for transmitting the intermediary chunks may occur in parallel with the memory and/or compute operations for processing the input chunks.

The intermediary chunks (e.g., C1-1, C2-1, C3-1, C4-1) may be processed by a distributed AI computing device 304b implementing an allocated portion of the distributed machine learning network including one or more decoder layers. Processing the intermediary chunks (e.g., C1-1, C2-1, C3-1, C4-1) may generate further intermediary chunks (e.g., C1-2, C2-2, C3-2, C4-2). The memory and compute operations for processing the intermediary chunks (e.g., C1-1, C2-1, C3-1, C4-1) may be implemented serially. The transmission operations for transmitting the intermediary chunks (e.g., C1-2, C2-2, C3-2, C4-2) may occur in parallel with the memory and/or compute operations for processing the intermediary chunks (e.g., C1-1, C2-1, C3-1, C4-1). Memory, compute, and transmission operations implemented by the distributed AI computing device 304b may be implemented in parallel with memory, compute, and transmission operations implemented by the distributed AI computing device 304a.

The intermediary chunks (e.g., C1-2, C2-2, C3-2, C4-2) may be processed by a distributed AI computing device 304c implementing an allocated portion of the distributed machine learning network including one or more decoder layers. Processing the intermediary chunks (e.g., C1-2, C2-2, C3-2, C4-2) may generate further intermediary chunks (not shown). The memory and compute operations for processing the intermediary chunks (e.g., C1-2, C2-2, C3-2, C4-2) may be implemented serially. The transmission operations for transmitting the further intermediary chunks may occur in parallel with the memory and/or compute operations for processing the intermediary chunks (e.g., C1-2, C2-2, C3-2, C4-2). Memory, compute, and transmission operations implemented by the distributed AI computing device 304c may be implemented in parallel with memory, compute, and transmission operations implemented by the distributed AI computing device 304a and/or the distributed AI computing device 304b.

Chunking of the input may enable parallel execution of the memory, compute, and transmission operations implemented by the computing devices 304a, 304b, 304c for implementing the distributed machine learning network. Leveraging chunking of the input and parallel execution of the operations for implementing the distributed machine learning network may reduce the token latency as compared to serial processing of a not chunked input in a non-distributed machine learning network or distributed machine learning network, as illustrated in FIG. 3A.

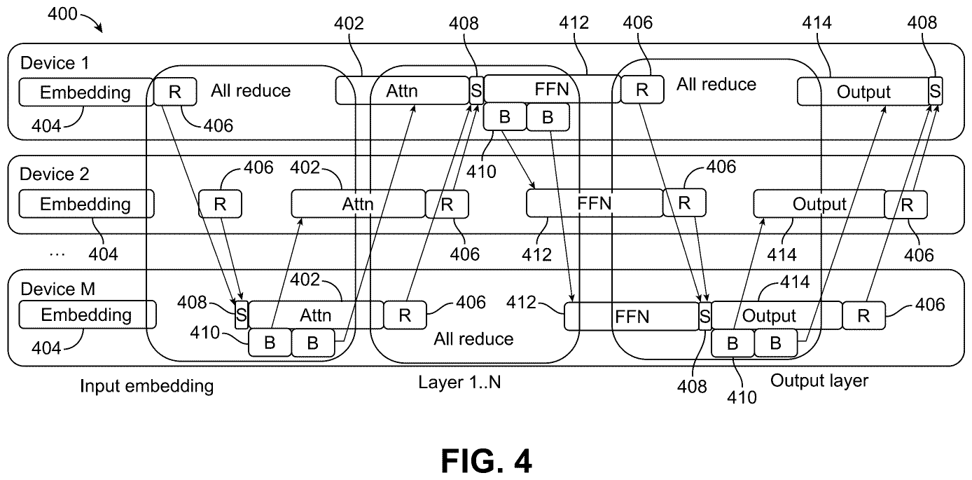

FIG. 4 is a block diagram 400 illustrating an example of tensor parallelization of a machine learning network. The machine learning network can be partitioned into portions (e.g., layers of the machine learning network) as further described in the description of FIG. 2. Layers of the machine learning network (such as attention layer 402) can be partitioned into an M number of portions based on the tensor parallelization being performed using an M number of devices. In some examples, the layers can include convolutional layers, feedforward networks, etc. In some examples, the attention layer 402 is a self-attention layer. In some examples, the M number of devices can include varying amounts of the weights, parameters, and tensors of the attention layer 402 based on characteristics of the devices.

The devices performing the tensor parallelization can process an input embedding 404 using the portions of the machine learning network (e.g., the portions of the attention layer 402 or other portions of other layers) corresponding to the device. In some examples, the input embedding 404 can be multiple instances (e.g., copies) of the same input embedding 404. In further examples, the input embedding 404 can be a representation (e.g., matrix, vector, array) of an input to the machine learning network or a representation of activations of layers of the machine learning network. In some examples, the input embedding 404 can include key-value (KV) pairs from a prefill stage of inference using the machine learning network. In further examples, the input embedding 404 can include a user prompt such as a text prompt, or an embedding representation of a user prompt.

The tensor parallelization example illustrated in the block diagram 400 includes a reduce operation 406, a synchronization operation 408, and a root broadcast operation 410. In such an example, the reduce operation 406 can represent an operation for combining results of processing the input embedding 404 (or other input to a portion of a layer of the machine learning network) into an output embedding. For example, the reduce operation 406 can include processing various outputs, gradients, activations, etc. of the portion of the layer of the machine learning network to generate the output embedding corresponding to the portion of the layer of the machine learning network.

Each device of the M devices can transmit or broadcast an output embedding to a root device to perform a synchronization operation 408. The synchronization operation 408 can be an operation for generating a combined output embedding associated with the layer of the machine learning network. For example, the output embeddings of individual devices can represent portions of the combined output embedding with the combined output embedding representing an output of the entire layer of the machine learning network.

For example, the synchronization operation 408 can include combining the output embeddings of the devices into a larger output embedding. In such an example, the output embeddings associated with portions of a layer of the machine learning network can represent a portion of a matrix or vector corresponding to the weights or parameters of the machine learning network used to process the input embedding 404. In such an example, the combined output embedding can be a matrix or vector representation combining the output embeddings of the devices.

The root broadcast operation 410 represents a transmission of the combined results of the synchronization operation 408 to the devices performing tensor parallelization. In such an example, the device which generated the combined output embedding can be referred to as a root device. The root device can transmit or broadcast the combined output embedding to one or more devices using unicast transmissions or multicast transmissions.

In some examples, the root device can transmit the combined output embedding in sequential order to the devices performing tensor parallelization. For example, the root device can transmit the combined output embedding in sequential order to devices in a predetermined sequence (e.g., broadcast first to a first device, broadcast second to a second device, etc.). In further examples, the sequential order of the transmission can be in order based on the order the devices provide an output embedding to the root device, or in a reverse sequential order of the order the devices provide output embeddings to the root device.

In some examples, the multiple devices can be root devices. For example, the block diagram 400 illustrates device M as being a first root device and device 1 as being a second root device. In such an example, the device generating the combined output embedding using the synchronization operation 408 can be referred to as a root device during a sequence of operation which the device is performing the synchronization operation 408 and broadcasting the combined output embedding during the root broadcast operation 410.

In some examples, the devices can include a feedforward network 412 of the machine learning network to process a combined output embedding associated with layers of the machine learning network. In some examples, the devices can include portions of the feedforward network 412 (e.g., portions sized based on specifications of the devices). In other examples, each device can include the entire feedforward network 412. For example, layers or components of the machine learning network which cannot be partitioned can be provided to each of the devices performing tensor parallelization.

The output of the feedforward network 412 can be transmitted by each device to a root device (such as device M). The root device can perform a synchronization operation 408 to combine the outputs of the feedforward network 412 to generate an additional combined output embedding. The root device can transmit the additional combined output embedding to the devices. The devices can process the additional combined output embedding using portions of an output layer 414 of the machine learning network. The output embeddings generated using the portions of the output layer 414 can be transmitted to the root device (e.g., device 1) to generate a final combined output embedding using a synchronization operation 408 of the output embeddings.

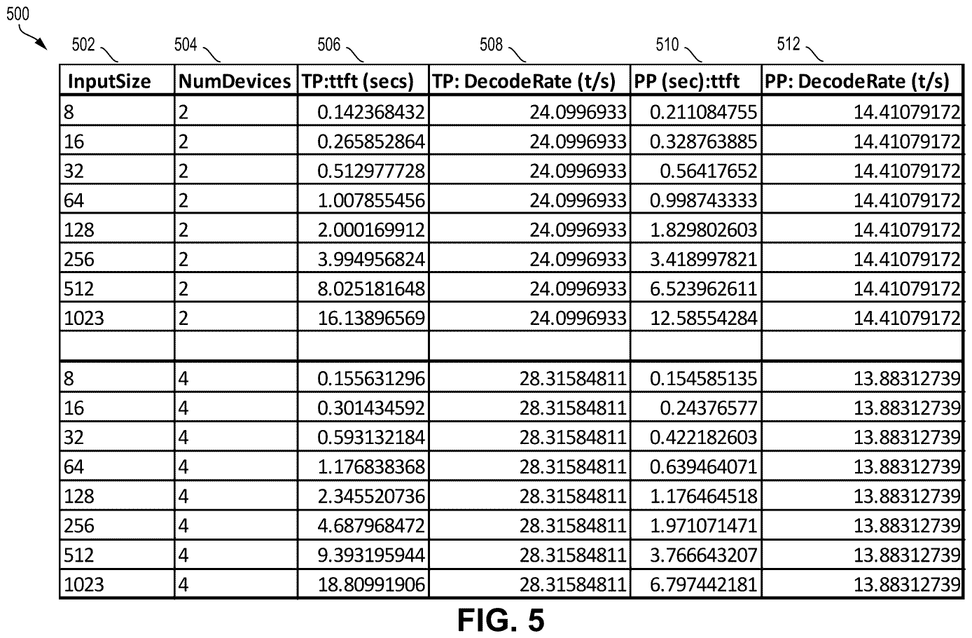

FIG. 5 is a block diagram illustrating an example look up table (LUT) 500. The LUT 500 provides a predetermined list of decode rates and token latency arranged in various rows and columns of the LUT 500. The columns and rows of the LUT 500 can be rearranged. For example, a first column of the LUT 500 can be rearranged to be a second column of the LUT 500, etc.

The LUT 500 includes a first column 502 sorting the decode rates and token latency based on an input size of the input embedding (or user prompt). For example, the input size can be represented in bits. The LUT 500 includes a second column 504 sorting the decode rates and token latency based on the number of devices used during parallelization. For example, higher numbers of devices (e.g., 5 or more devices) generally demonstrate lower token latency over most input sizes. The third column 506 indicates example token latencies for tensor parallelization (e.g., a time to first token latency). A fourth column 508 can indicate a decode rate for tensor parallelization for various input sizes and number of devices used during parallelization. A fifth column 510 can indicate token latencies, such as a time to first token latency, for devices performing pipeline parallelization. A sixth column 512 of the LUT 500 indicates a decode rate of devices performing pipeline parallelization.

Generally, tensor parallelization has a faster decode rate (e.g., higher decode rate) than pipeline parallelization across input sizes and number of devices used during parallelization. The higher decode rate when using tensor parallelization indicates that tensor parallelization during a decode stage of a machine learning network during inference is generally faster than pipeline parallelization. The token latency rates indicated in the third column 506 and the fifth column 510 indicate that generally pipeline parallelization is more efficient during a prefill stage of the machine learning network. For example, the pipeline parallelization token latencies are generally lower than tensor parallelization, indicating pipeline parallelization to be faster.

The LUT 500 can be particular to a set or plurality of devices. For example, token latency and decode rates can be based on specifications of the devices and connection between the devices (e.g., communication latency, compute latency, etc.).

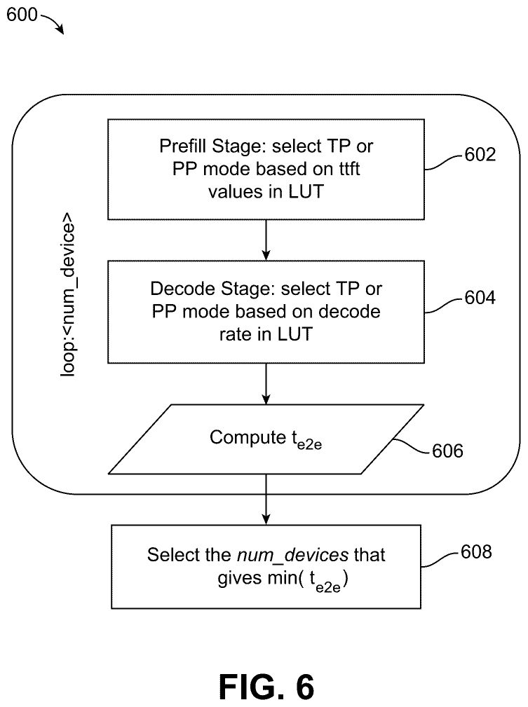

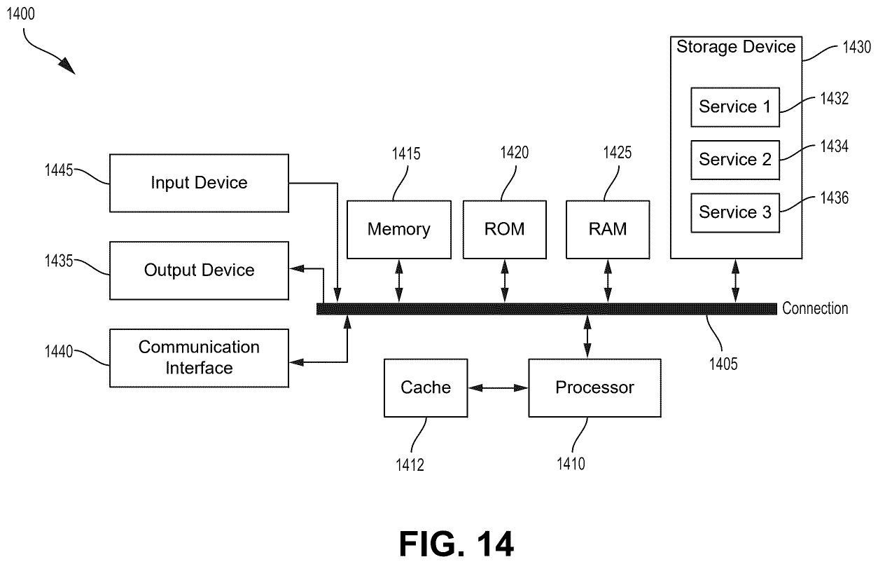

FIG. 6 is a flow diagram illustrating an example of a process 600 for determining a number of devices to use when performing tensor parallelism (e.g., a tensor parallelism mode) or pipeline parallelism (e.g., a pipeline parallelism mode) for a prefill stage and decode stage of a machine learning network during inference. The process 600 can further indicate which parallelism to use (e.g., pipeline parallelism or tensor parallelism). In some examples, determinations can be based on a look up table (LUT) of values such as a list of decode rates and token latency. In some examples, the LUT can be stored in memory, or can be generated during the process 600. The process 600 can be performed by a computing device (e.g., the SOC 100 of FIG. 1, the computing device or computing system 1400 of FIG. 14, etc.) or by a component or system, a chipset, one or more processors central processing units (CPUs), digital signal processors (DSPs), graphics processing units (GPUs), any other type of processor(s), any combination thereof, or other component or system) of the computing device. The operations of the process 600 can be implemented as software components that are executed and run on one or more processors (e.g., processor 1410 of FIG. 14 or other processor(s)) of the computing device. Further, the transmission and reception of signals by the computing device in the process 600 can be enabled, for example, by one or more antennas, one or more microphones, and/or one or more transceivers (e.g., wireless transceiver(s)).

At block 602, the computing device (or component thereof) can select a tensor parallelization mode or a pipeline parallelization mode for a prefill stage of the machine learning network based on a token latency (e.g., a time to first token latency). The token latency can be determined based on referencing a LUT, such as the LUT 500 of FIG. 5. For example, the computing device (or component thereof) can be a device of a plurality of devices. The computing device (or component thereof) can compare the token latency for pipeline parallelization and tensor parallelization represented in the LUT for various numbers of device configurations (e.g., configurations including three devices, configurations including four devices, to configurations including N devices). The computing device (or component thereof) can iterate through the device configurations or can select a tensor parallelization mode or pipeline parallelization mode based on the token latency (e.g., selecting the lowest time to first token latency from the LUT).

At block 604, the computing device (or component thereof) can select a tensor parallelization mode or a pipeline parallelization mode for a decode stage of the machine learning network based on a decode rate associated with the selected mode. The decode rate can be determined based on referencing a LUT, such as the LUT 500 of FIG. 5. The computing device (or component thereof) can compare the decode rate for pipeline parallelization and tensor parallelization represented in the LUT for various numbers of device configurations. The computing device (or component thereof) can iterate through the numbers of device configurations or can select a tensor parallelization mode or pipeline parallelization mode based on the decode rate (e.g., selecting the highest decode rate).

At block 606, the computing device (or component thereof) can compute, based on the selected tensor parallelization mode or pipeline parallelization mode during the prefill stage and the decode stage, an end-to-end token latency (e.g., tₑ₂ₑ) which can be represented as tₑ₂ₑ=t_{ttft}+t_{decode}. In such an example, the values for t_{ttft} and t_{decode} can be determined from the LUT. In some examples, the process 600 can iterate through each number configuration of devices available to be used for parallelization (e.g., when there are 10 devices which can be used for parallelization, the process can iterate through each configuration of devices from 2 devices to 10 devices to be used for parallelization).

At block 608, the computing device (or component thereof) can select the number of devices to use when performing parallelization. For example, the computing device (or component thereof) can select the number of devices to be the number of devices providing the lowest end-to-end token latency, represented as min(tₑ₂ₑ).

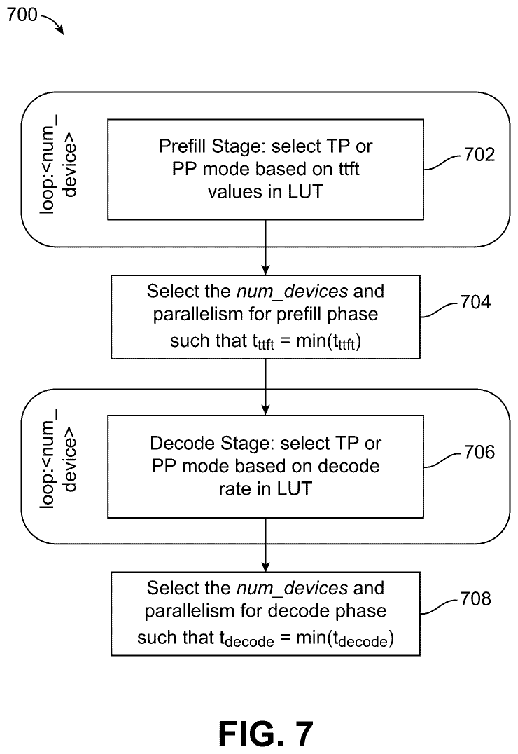

FIG. 7 is a flow diagram illustrating an example of a process 700 for determining a number of devices to use when performing tensor parallelism (e.g., a tensor parallelism mode) or pipeline parallelism (e.g., a pipeline parallelism mode) for a prefill stage and decode stage of a machine learning network during inference. For example, FIG. 7 illustrates a flow diagram of an example process where the number of devices used during parallelization of the prefill stage and the decode stage is different. For example, the number of devices used for pipeline parallelism can be different than the number of devices used for tensor parallelism. For example, the devices used for pipeline parallelism can be a subset of devices of the number of devices used for tensor parallelism.

At block 702, the computing device (or component thereof) can select a tensor parallelization mode, or a pipeline parallelization mode associated with a prefill stage of the machine learning network based on a token latency (e.g., a time to first token latency). The token latency can be determined based on the LUT (e.g., based on recorded token latency values in the LUT), such as the LUT 500 of FIG. 5. The computing device (or component thereof) can compare the token latency for pipeline parallelization and tensor parallelization represented in the LUT for various numbers of device configurations to determine whether to select tensor parallelization or pipeline parallelization to use during a prefill stage. The computing device (or component thereof) can select the number of devices to use based on the token latency. For example, the computing device (or component thereof) can select the number of devices to use by selecting a parallelization mode and number of devices associated with a lowest token latency from the LUT.

At block 704, the computing device (or component thereof) can select or determine the number of devices to use for parallelization during a prefill stage of the machine learning network. In such an example, the computing device (or component thereof) can select or determine the number of devices to use based on the token latency for various number configurations of the devices (e.g. token latency associated with 2 devices, token latency associated with 4 devices, etc.). For example, the number of devices determined to be used can be associated with the lowest token latency from the LUT which the computing device (or component thereof) can accommodate. For example, the computing device (or component thereof) can have available a preset number of devices (such as 10 devices to be used for parallelization). In such an example, the computing device can determine, based on the token latencies associated with tensor parallelization and pipeline parallelization (as recorded in the LUT), how many of the 10 devices to use during parallelization to select a minimum token latency.

At block 706, the computing device (or component thereof) can select a tensor parallelization mode or a pipeline parallelization mode for a decode stage of the machine learning network based on a decode rate associated with the selected parallelization mode. The decode rate can be determined based on referencing a LUT, such as the LUT 500 of FIG. 5. The computing device (or component thereof) can compare the decode rate for pipeline parallelization and tensor parallelization represented in the LUT for various numbers of device configurations. The computing device (or component thereof) can iterate through the numbers of device configurations or can select a tensor parallelization mode or pipeline parallelization mode based on the decode rate (e.g., selecting the highest decode rate).

At block 708, the computing device (or component thereof) can select or determine the number of devices to use during the decode stage based on decode rates of the number configurations of devices. For example, the computing device (or component thereof) can determine the number of devices (e.g., number of devices available to be used during parallelization) to use to provide the highest decode rate (or a minimum token latency associated with the decode stage) during the decode stage.

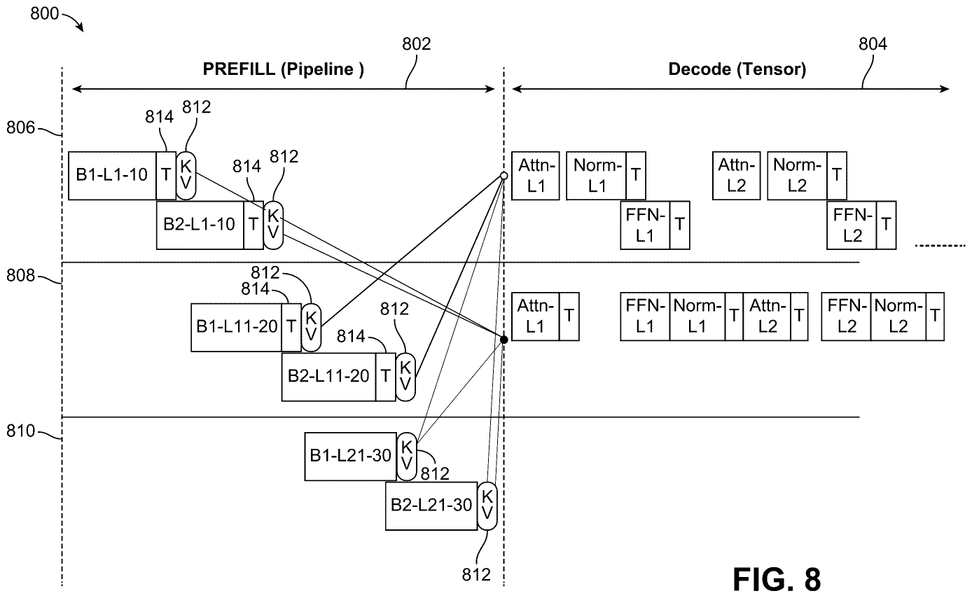

FIG. 8 is a block diagram 800 illustrating an example using pipeline parallelism in a prefill stage 802 of the machine learning network and tensor parallelism in a decode stage 804 of the machine learning network. By way of example, the pipeline parallelism in the prefill stage 802 is performed using three devices (e.g., a first device 806, a second device 808, and a third device 810). The tensor parallelism in the decode stage 804 is performed using two devices (e.g., the first device 806 and the second device 808).

The pipeline parallelism in the prefill stage 802 can include processing portions of layers of the machine learning network to generate key-value (KV) pairs 812. The key-value pairs can be stored in a cache of a corresponding device. For example, each device (the first device 806, the second device 808, and the third device) can process an input embedding or input prompt using a portion of the machine learning network corresponding to the device. For example, the first device 806 includes two batches of input tokens (B1 and B2) of ten layers of the machine learning network (e.g., L1-10), the second device includes two batches of input tokens (B1 and B2) of ten additional layers of the machine learning network (e.g., L11-L20), and the third device includes two batches of input tokens (B1 and B2) of ten additional layers of the machine learning network (e.g., L21-L30).

The devices can process an input embedding or input prompt using the portions of the layers of the machine learning network to generate the KV pairs 812. The first device 806 can determine KV pairs 812 associated with portions of the machine learning network and transfer the KV pairs 812 to a cache of another device (e.g., from a cache of the first device 806 to a cache of the second device 808, or vice versa) to be used as inputs to layers of the machine learning network during the decode stage 804. The time period for transmission of the KV pairs 812 to a cache of another device is represented by transmission time 814 (T). In further examples, the KV pairs 812 can be sent to multiple devices or an individual device for further processing.

During the decode stage 804, the devices (e.g., the first device 806 and the second device 808) can process the KV pairs 812 stored in caches of the first device 806 and the second device 808 to generate output embeddings associated with layers of the machine learning network (e.g., L1, L2, etc.). The first device 806 and the second device 808 can use tensor parallelization (further described in the description of FIG. 2, FIG. 3A, and FIG. 3B) to generate output embeddings using the KV pairs 812.

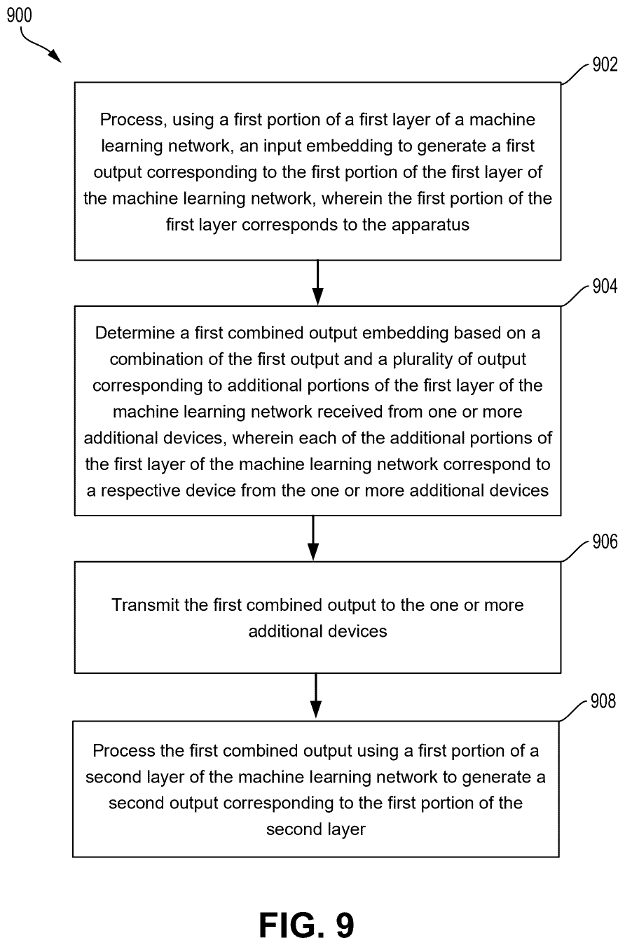

FIG. 9 is a flow chart illustrating an example of a process 900 for machine learning processing, such as to perform tensor parallelization. The process 900 can be performed by a computing device (e.g., the SOC 100 of FIG. 1, the computing device or computing system 1400 of FIG. 14, etc.) or by a component or system, a chipset, one or more processors central processing units (CPUs), digital signal processors (DSPs), graphics processing units (GPUs), any other type of processor(s), any combination thereof, or other component or system) of the computing device. The operations of the process 900 can be implemented as software components that are executed and run on one or more processors (e.g., processor 1410 of FIG. 14 or other processor(s)) of the computing device. Further, the transmission and reception of signals by the computing device in the process 900 can be enabled, for example, by one or more antennas, one or more microphones, and/or one or more transceivers (e.g., wireless transceiver(s)).

At block 902, the computing device (or component thereof) can process an input embedding to generate a first output corresponding to the first portion of the first layer of the machine learning network. For example, the computing device (or component thereof) can use a first portion of a first layer of a machine learning network to process the input embedding to generate the first output. In some examples, the first portion of the first layer can correspond to the computing device (or component thereof) processing the input embedding. In further examples, the computing device or another device can partition the machine learning network into a plurality of portions (such as the first portion, a second portion, etc.). In such an example, the size of the first portion of the first layer and respective sizes of the additional portions of the first layer can be determined based on processing power of the computing device and processing power of the one or more additional devices.

In some examples, the sizes of the portions of the machine learning network can be different for one or more of the computing device and the one or more additional devices. For example, a device can include more processing power than another device from the one or more additional devices. In such an example, the device including more processing power can receive a larger portion of the machine learning network than another device including less processing power. In such an example, the portion of the machine learning network received by the devices (and processed using the devices) can be sized such that each device receiving a portion of the machine learning network can process respective portions in substantially the same period of time. In another example the first layer can be a self-attention layer of the machine learning network. In further examples, the first layer can be a block of layers. For example, the first layer can include a plurality of layers, such as a plurality of self-attention layers of the machine learning network.

At block 904, the computing device (or component thereof) can determine a first combined output embedding based on a combination of the first output and a plurality of outputs corresponding to additional portions of the first layer of the machine learning network received from one or more additional devices. In such an example, each of the additional portions of the first layer of the machine learning network can correspond to a respective device from the one or more additional devices. In further examples, each device of the one or more additional devices can process an instance of the input embedding.

At block 906, the computing device (or component thereof) can transmit the first combined output to the one or more additional devices. In some examples, the first combined output can be transmitted as a unicast or multicast transmissions. For example, the computing device can transmit the combined output to an individual device of the one or more additional devices. In other examples, the computing device can transmit the combined output to each of the one or more additional devices.

At block 908, the computing device (or component thereof) can process the first combined output using a first portion of a second layer of the machine learning network to generate a second output corresponding to the first portion of the second layer. In some examples, the computing device (or component thereof) can transmit the second output embedding to a first device from the one or more additional devices. For example, the transmission can be a unicast transmission to the first device from the one or more additional devices. In further examples, the computing device (or component thereof) can receive a second combined output from the first devices. In such an example, the second combined output can correspond to a combination of the second output and a second plurality of output corresponding to additional portions of the second layer of the machine learning network. In further examples, the computing device (or component thereof) can process the second combined output to generate a third output corresponding to the first portion of the third layer of the machine learning network. In such an example, the computing device (or component thereof) can use a first portion of a third layer of the machine learning network to process the second combined output. In another example, the computing device (or component thereof) can determine a third combined output based on a combination of the third output and a plurality of outputs. In such an example, the plurality of outputs can correspond to additional portions of the third layer of the machine learning network.

In another example, the computing device (or component thereof) can transmit the first combined output to each device of the one or more additional devices in a sequential order. For example, the computing device can transmit the combined output as unicast transmissions to the one or more additional devices in a predetermined order. In such an example, the first devices can receive the first combined output last in the sequential order. In another example, each of the one or more additional devices can receive the second combined output in the sequential order. In such an example, the computing device (or component thereof) can receive the second combined output last in the sequential order. In a further example, the sequential order of transmission of the second combined output can be a reverse order of the sequential order of transmission of the first combined output.

FIG. 10 is a flow chart illustrating an example of a process 1000 for machine learning processing, such as to perform pipeline parallelization and tensor parallelization. The process 1000 can be performed by a computing device (e.g., the SOC 100 of FIG. 1, the computing device or computing system 1400 of FIG. 14, etc.) or by a component or system, a chipset, one or more processors central processing units (CPUs), digital signal processors (DSPs), graphics processing units (GPUs), any other type of processor(s), any combination thereof, or other component or system) of the computing device. The operations of the process 1000 can be implemented as software components that are executed and run on one or more processors (e.g., processor 1410 of FIG. 14 or other processor(s)) of the computing device. Further, the transmission and reception of signals by the computing device in the process 1000 can be enabled, for example, by one or more antennas, one or more microphones, and/or one or more transceivers (e.g., wireless transceiver(s)).

At block 1002, the computing device (or component thereof) can determine to process an input embedding to generate key-value pairs using a pipeline parallelization mode of the computing device. For example, the pipeline parallelization mode can include performing pipeline parallelization to process input embeddings, such as the pipeline parallelization described in the descriptions of FIG. 3A-3B, FIG. 7, FIG. 8, and FIG. 9. In some examples, the computing device (or component thereof) can determine to process the input embedding to generate the key-value pairs using the pipeline parallelization mode of the computing device by comparing a token latency associated with the pipeline parallelization mode and a token latency associated with the tensor parallelization mode to determine the pipeline parallelization mode is associated with a lower token latency. In such an example, the computing device can determine a parallelization mode (e.g., the tensor parallelization mode or pipeline parallelization mode) based on which mode is associated with a lower token latency. For example, the token latency can be an end-to-end token latency. In such an example, the end-to-end token latency can be associated with a time period for processing inputs to a machine learning network and generating an output.

In some examples, the token latency can be determined from a look up table (LUT) of token latency values. For example, the LUT can be the LUT 500 of FIG. 5. In another example, the token latency is based on at least one of a data link speed, an input prompt size, a number of devices in the first plurality of devices, or an expected key-value pair size.

At block 1004, the computing device (or component thereof) can process the input embedding to generate the key-value pairs based on the pipeline parallelization mode of the computing device. The computing device (or component thereof) can partition a machine learning network into a plurality of portions. For example, each portion of the plurality of portions can correspond to one or more layers of the machine learning network. In another example, each portion of the plurality of portions corresponds to a respective device from a first plurality of devices. In some examples, the computing device (or component thereof) can process the input embedding to generate the key-value pairs using a portion of the machine learning network.

At block 1006, the computing device (or component thereof) can determine to decode the key-value pairs using a tensor parallelization mode of the computing device. For example, determining to decode the key-value pairs using the tensor parallelization mode can include comparing a decode rate associated with the pipeline parallelization mode and a decode rate associated with the tensor parallelization mode. In such an example, the comparison of the decode rate associated with the pipeline parallelization mode and a decode rate associated with the tensor parallelization mode to determine the tensor parallelization mode is associated with a higher decode rate. For example, the computing device can determine to use the tensor parallelization mode based on the decode rate being higher than the decode rate associated with the pipeline parallelization rate. In some examples, the decode rate of the pipeline parallelization mode and the decode rate of the tensor parallelization mode can be determined from a look up table (LUT) of token latency values and decode rate values.

At block 1008, the computing device (or component thereof) can generate an output based on the tensor parallelization mode of the computing device. For example, to generate the output embedding based on the tensor parallelization mode of the apparatus, the computing device can process the key-value pairs to generate a first output (e.g., a first output embedding). For example, the computing device can use a first portion of a first layer of the machine learning network to process the key-value pairs. In such an example, the first output can correspond to the first portion of the first layer of the machine learning network. The computing device (or component thereof) can transmit the first output embedding corresponding to the first portion of the first layer of the machine learning network to a device from a second plurality of devices. In some examples, the second plurality of device can include a subset of devices from the first plurality of devices or a separate set of devices from the first plurality of devices. For example, the first plurality of devices can include more devices than the second plurality of devices (or vice versa).

In another example, the computing device (or component thereof) can transfer the key-value pairs from a first cache associated with a first layer of a machine learning network generated based on the pipeline parallelization mode to a second cache associated with the second layer of the machine learning network to process the key-value pairs based on the tensor parallelization mode. In some examples, the computing device (or component thereof) can process additional key-value pairs in parallel with the transfer.

FIG. 11 is an illustrative example of a deep learning neural network 1100 that can be used by a machine learning system. An input layer 1120 includes input data. In one illustrative example, the input layer 1120 can include data representing the pixels of an input image or video frame. The neural network 1100 includes multiple hidden layers 1122a, 1122b, through 1122n. The hidden layers 1122a, 1122b, through 1122n include “n” number of hidden layers, where “n” is an integer greater than or equal to one. The number of hidden layers can be made to include as many layers as needed for the given application. The neural network 1100 further includes an output layer 1124 that provides an output resulting from the processing performed by the hidden layers 1122a, 1122b, through 1122n. In one illustrative example, the output layer 1124 can provide a classification for an object in an input image or video frame. The classification can include a class identifying the type of object (e.g., a static object, a vehicle, a person, a dog, a cat, or other object).

The neural network 1100 is a multi-layer neural network of interconnected nodes. Each node can represent a piece of information. Information associated with the nodes is shared among the different layers and each layer retains information as information is processed. In some cases, the neural network 1100 can include a feed-forward network, in which case there are no feedback connections where outputs of the network are fed back into itself. In some cases, the neural network 1100 can include a recurrent neural network, which can have loops that allow information to be carried across nodes while reading in input.

Information can be exchanged between nodes through node-to-node interconnections between the various layers. Nodes of the input layer 1120 can activate a set of nodes in the first hidden layer 1122a. For example, as shown, each of the input nodes of the input layer 1120 is connected to each of the nodes of the first hidden layer 1122a. The nodes of the hidden layers 1122a, 1122b, through 1122n can transform the information of each input node by applying activation functions to the information. The information derived from the transformation can then be passed to and can activate the nodes of the next hidden layer 1122b, which can perform their own designated functions. Example functions include convolutional, up-sampling, data transformation, and/or any other suitable functions. The output of the hidden layer 1122b can then activate nodes of the next hidden layer, and so on. The output of the last hidden layer 1122n can activate one or more nodes of the output layer 1124, at which an output is provided. In some cases, while nodes (e.g., node 1126) in the neural network 1100 are shown as having multiple output lines, a node has a single output and all lines shown as being output from a node represent the same output value.

In some cases, each node or interconnection between nodes can have a weight that is a set of parameters derived from the training of the neural network 1100. Once the neural network 1100 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 1100 to be adaptive to inputs and able to learn as more and more data is processed.

The neural network 1100 is pre-trained to process the features from the data in the input layer 1120 using the different hidden layers 1122a, 1122b, through 1022n in order to provide the output through the output layer 1124. In an example in which the neural network 1100 is used to identify objects in images, the neural network 1100 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the neural network 1100 can adjust the weights of the nodes using a training process called backpropagation. Backpropagation can include a forward pass, a loss function, a backward pass, and a weight update. The forward pass, loss function, backward pass, and parameter update are performed for one training iteration. The process can be repeated for a certain number of iterations for each set of training images until the neural network 1100 is trained well enough so that the weights of the layers are accurately tuned.

For the example of identifying objects in images, the forward pass can include passing a training image through the neural network 1100. The weights are initially randomized before the neural network 1100 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 1100, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 1100 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times the actual answer minus the predicted (output) answer squared. The loss can be set to be equal to the value of Eₜₒₜₐₗ.

The loss (or error) will be high for the first training images since the actual values can be different than the predicted output. The goal of training is to minimize the amount of loss so that the predicted output is the same as the training label. The neural network 1100 can perform a backward pass by determining which inputs (weights) most contributed to the loss of the network and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and η denotes a learning rate. The learning rate can be set to any suitable value, with a high learning rate including larger weight updates and a lower value indicating smaller weight updates.

The neural network 1100 can include any suitable deep network. One example includes a convolutional neural network (CNN), which includes an input layer and an output layer, with multiple hidden layers between the input and out layers. An example of a CNN is described below with respect to FIG. 12. The hidden layers of a CNN include a series of convolutional, nonlinear, pooling (for downsampling), and fully connected layers. The neural network 1100 can include any other deep network other than a CNN, such as an autoencoder, a deep belief nets (DBNs), a Recurrent Neural Networks (RNNs), among others.

FIG. 12 is an illustrative example of a convolutional neural network 1200 (CNN 1200). The input layer 1220 of the CNN 1200 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1222a, an optional non-linear activation layer, a pooling hidden layer 1222b, and fully connected hidden layers 1222c to get an output at the output layer 1224. While only one of each hidden layer is shown in FIG. 12, one of ordinary skill will appreciate that multiple convolutional hidden layers, non-linear layers, pooling hidden layers, and/or fully connected layers can be included in the CNN 1200. As previously described, the output can indicate a single class of an object or can include a probability of classes that best describe the object in the image.

The first layer of the CNN 1200 is the convolutional hidden layer 1222a. The convolutional hidden layer 1222a analyzes the image data of the input layer 1220. Each node of the convolutional hidden layer 1222a is connected to a region of nodes (pixels) of the input image called a receptive field. The convolutional hidden layer 1222a can be considered as one or more filters (each filter corresponding to a different activation or feature map), with each convolutional iteration of a filter being a node or neuron of the convolutional hidden layer 1222a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1222a. Each connection between a node and a receptive field for that node learns a weight and, in some cases, an overall bias such that each node learns to analyze its particular local receptive field in the input image. Each node of the hidden layer 1222a will have the same weights and bias (called a shared weight and a shared bias). For example, the filter has an array of weights (numbers) and the same depth as the input. A filter will have a depth of 3 for the image or video frame example (according to three color components of the input image). An illustrative example size of the filter array is 5×5×3, corresponding to a size of the receptive field of a node.

The convolutional nature of the convolutional hidden layer 1222a is due to each node of the convolutional layer being applied to its corresponding receptive field. For example, a filter of the convolutional hidden layer 1222a can begin in the top-left corner of the input image array and can convolve around the input image. As noted above, each convolutional iteration of the filter can be considered a node or neuron of the convolutional hidden layer 1222a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1222a. For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1222a.

The mapping from the input layer to the convolutional hidden layer 1222a is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 1222a can include several activation maps in order to identify multiple features in an image. The example shown in FIG. 12 includes three activation maps. Using three activation maps, the convolutional hidden layer 1222a can detect three different kinds of features, with each feature being detectable across the entire image.

In some examples, a non-linear hidden layer can be applied after the convolutional hidden layer 1222a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1200 without affecting the receptive fields of the convolutional hidden layer 1222a.

The pooling hidden layer 1222b can be applied after the convolutional hidden layer 1222a (and after the non-linear hidden layer when used). The pooling hidden layer 1222b is used to simplify the information in the output from the convolutional hidden layer 1222a. For example, the pooling hidden layer 1222b can take each activation map output from the convolutional hidden layer 1222a and generates a condensed activation map (or feature map) using a pooling function. Max-pooling is one example of a function performed by a pooling hidden layer. Other forms of pooling functions can be used by the pooling hidden layer 1222a, such as average pooling, L2-norm pooling, or other suitable pooling functions. A pooling function (e.g., a max-pooling filter, an L2-norm filter, or other suitable pooling filter) is applied to each activation map included in the convolutional hidden layer 1222a. In the example shown in FIG. 12, three pooling filters are used for the three activation maps in the convolutional hidden layer 1222a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 1222a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1222a having a dimension of 24×24 nodes, the output from the pooling hidden layer 1222b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

Intuitively, the pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1200.

The final layer of connections in the network is a fully-connected layer that connects every node from the pooling hidden layer 1222b to every one of the output nodes in the output layer 1224. Using the example above, the input layer includes 28×28 nodes encoding the pixel intensities of the input image, the convolutional hidden layer 1222a includes 3×24×24 hidden feature nodes based on application of a 5×5 local receptive field (for the filters) to three activation maps, and the pooling layer 1222b includes a layer of 3×12×12 hidden feature nodes based on application of max-pooling filter to 2×2 regions across each of the three feature maps. Extending this example, the output layer 1124 can include ten output nodes. In such an example, every node of the 3×12×12 pooling hidden layer 1222b is connected to every node of the output layer 1224.

The fully connected layer 1222c can obtain the output of the previous pooling layer 1222b (which should represent the activation maps of high-level features) and determines the features that most correlate to a particular class. For example, the fully connected layer 1222c layer can determine the high-level features that most strongly correlate to a particular class and can include weights (nodes) for the high-level features. A product can be computed between the weights of the fully connected layer 1222c and the pooling hidden layer 1222b to obtain probabilities for the different classes. For example, if the CNN 1200 is being used to predict that an object in an image or video frame is a vehicle, high values will be present in the activation maps that represent high-level features of vehicles (e.g., two or four tires, a windshield, side view mirrors, etc.).

In some examples, the output from the output layer 1224 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.9 0 0 0 0], the vector indicates that there is a 5% probability that the image is the third class of object (e.g., a person), an 80% probability that the image is the fourth class of object (e.g., a static object on a road or other driving surface), and a 9% probability that the image is the sixth class of object (e.g., a vehicle). The probability for a class can be considered a confidence level that the object is part of that class.

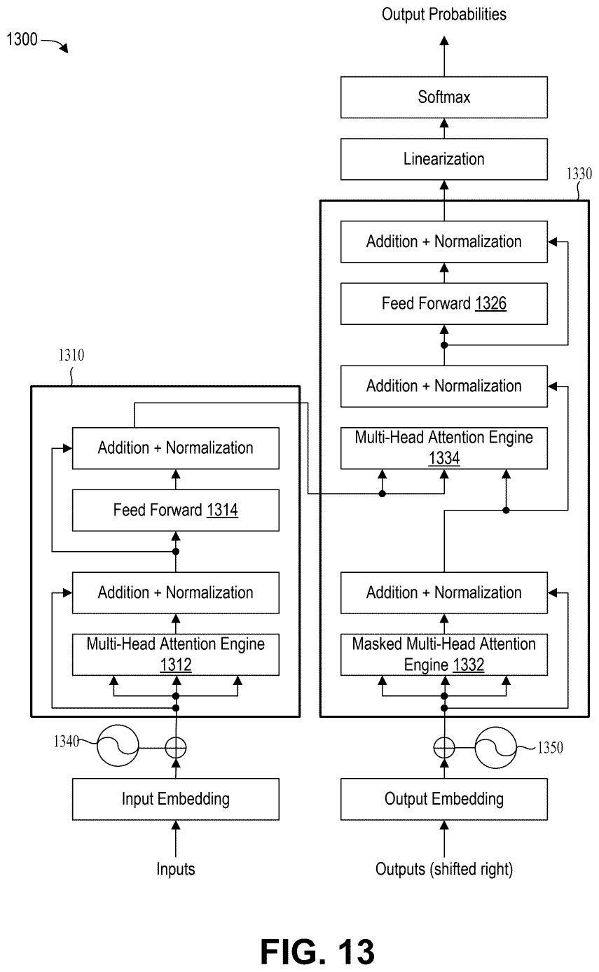

FIG. 13 is a block diagram of an example transformer in accordance with some aspects of the disclosure.

In a convolutional neural network (CNN) model, the number of operations required to relate signals from two arbitrary input or output positions grows in the distance between positions, which makes learning dependencies at different distant positions challenging for a CNN model. A transformer 1300 reduces the operations of learning dependencies by using an encoder 1310 and a decoder 1330 that can implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 1310 is composed of a stack of six identical layers and each layer has two sub-layers. The first sub-layer is a multi-head self-attention engine 1312, and the second sub-layer is a fully connected feed-forward network 1314. A residual connection (not shown) connects around each of the sub-layers followed by normalization.

In this example transformer 1300, the decoder 1330 is also composed of a stack of six 6 identical layers. The decoder also includes a masked multi-head self-attention engine 1332, a multi-head attention engine 1334 over the output of the encoder 1310, and a fully connected feed-forward network 1326. Each layer includes a residual connection (not shown) around the layer, which is followed by layer normalization. The masked multi-head self-attention engine 1332 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 1340 to encode positions because the model does not contain recurrence and convolution, and relative or absolute position of the tokens is needed. In the transformer 1300, the positional encodings are added to the input embeddings at the bottom layer of the encoder 1310 and the decoder 1330. The positional encodings are summed with the embeddings because the positional encodings and embeddings have the same dimensions. A corresponding position decoder 1350 is configured to decode the positions of the embeddings for the decoder 1330.

In some aspects, the transformer 1300 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 1300 can process input sequences of variable length, making it well-suited for natural language processing tasks where input lengths can vary greatly. Additionally, the self-attention mechanism allows the transformer 1300 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 14 illustrates an example computing system 1400 of an example computing device which can implement the various techniques described herein. For example, the computing system 1400 can implement the machine learning system described in the descriptions of FIG. 2-FIG. 9. The components of computing system 1400 are shown in electrical communication with each other using connection 1405, such as a bus. The example computing system 1400 includes a processing unit (CPU or processor) 1410 and computing device connection 1405 that couples various computing device components including computing device memory 1415, such as read only memory (ROM) 1420 and random access memory (RAM) 1425, to processor 1410.

Computing system 1400 can include a cache of high-speed memory connected directly with, in close proximity to, or integrated as part of processor 1410. Computing system 1400 can copy data from memory 1415 and/or the storage device 1430 to cache 1412 for quick access by processor 1410. In this way, the cache can provide a performance boost that avoids processor 1410 delays while waiting for data. These and other modules can control or be configured to control processor 1410 to perform various actions. Other computing device memory 1415 may be available for use as well. Memory 1415 can include multiple different types of memory with different performance characteristics. Processor 1410 can include any general purpose processor and a hardware or software service, such as service 1 1432, service 2 1434, and service 3 1436 stored in storage device 1430, configured to control processor 1410 as well as a special-purpose processor where software instructions are incorporated into the processor design. Processor 1410 may be a self-contained system, containing multiple cores or processors, a bus, memory controller, cache, etc. A multi-core processor may be symmetric or asymmetric.

To enable user interaction with the computing system 1400, input device 1445 can represent any number of input mechanisms, such as a microphone for speech, a touch-sensitive screen for gesture or graphical input, keyboard, mouse, motion input, speech and so forth. Output device 1435 can also be one or more of a number of output mechanisms known to those of skill in the art, such as a display, projector, television, speaker device, etc. In some instances, multimodal computing devices can enable a user to provide multiple types of input to communicate with computing system 1400. Communication interface 1440 can generally govern and manage the user input and computing device output. There is no restriction on operating on any particular hardware arrangement and therefore the basic features here may easily be substituted for improved hardware or firmware arrangements as they are developed.

Storage device 1430 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1425, read only memory (ROM) 1420, and hybrids thereof. Storage device 1430 can include services 1432, 1434, 1436 for controlling processor 1410. Other hardware or software modules are contemplated. Storage device 1430 can be connected to the computing device connection 1405. In one aspect, a hardware module that performs a particular function can include the software component stored in a computer-readable medium in connection with the necessary hardware components, such as processor 1410, connection 1405, output device 1435, and so forth, to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process can be terminated when its operations are completed but could have additional steps not included in the figures. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for machine learning processing, at least one memory; and at least one processor coupled to the at least one memory and configured to: process, using a first portion of a first layer of a machine learning network, an input embedding to generate a first output corresponding to the first portion of the first layer of the machine learning network, wherein the first portion of the first layer corresponds to the apparatus; determine a first combined output embedding based on a combination of the first output and a plurality of outputs corresponding to additional portions of the first layer of the machine learning network received from one or more additional devices, wherein each of the additional portions of the first layer of the machine learning network correspond to a respective device from the one or more additional devices; transmit the first combined output to the one or more additional devices; and process the first combined output using a first portion of a second layer of the machine learning network to generate a second output corresponding to the first portion of the second layer.

Aspect 2. The apparatus of Aspect 1, wherein the at least one processor is configured to: transmit the second output embedding to a first device from the one or more additional devices; receive, from the first device, a second combined output, wherein the second combined output corresponds to a combination of the second output and a second plurality of output corresponding to additional portions of the second layer of the machine learning network; process, using a first portion of a third layer of the machine learning network, the second combined output to generate a third output corresponding to the first portion of the third layer of the machine learning network; and determine, based on a combination of the third output and a plurality of outputs corresponding to additional portions of the third layer of the machine learning network, a third combined output.

Aspect 3. The apparatus of any of Aspects 1 to 2, wherein transmissions of the first combined output and the second output are unicast transmissions.

Aspect 4. The apparatus of any of Aspects 1 to 3, wherein the at least one processor is configured to: transmit the first combined output to each device of the one or more additional devices in a sequential order.

Aspect 5. The apparatus of any of Aspects 1 to 4, wherein the first device receives the first combined output last in the sequential order.

Aspect 6. The apparatus of any of Aspects 1 to 5, wherein each of the one or more additional devices receive the second combined output in the sequential order, and wherein the apparatus receives the second combined output last in the sequential order.

Aspect 7. The apparatus of any of Aspects 1 to 6, wherein the sequential order of transmission of the second combined output is a reverse order of the sequential order of transmission of the first combined output.

Aspect 8. The apparatus of any of Aspects 1 to 7, wherein each device of the one or more additional devices processes an instance of the input embedding.

Aspect 9. The apparatus of any of Aspects 1 to 8, wherein a size of the first portion of the first layer and respective sizes of the additional portions of the first layer are determined based on processing power of the apparatus and processing power of the one or more additional devices.

Aspect 10. The apparatus of any of Aspects 1 to 9, wherein the first layer is a self-attention layer of the machine learning network.

Aspect 11. A method comprising: processing, using a first portion of a first layer of a machine learning network, an input embedding to generate a first output corresponding to the first portion of the first layer of the machine learning network, wherein the first portion of the first layer corresponds to the apparatus; determining a first combined output embedding based on a combination of the first output and a plurality of outputs corresponding to additional portions of the first layer of the machine learning network received from one or more additional devices, wherein each of the additional portions of the first layer of the machine learning network correspond to a respective device from the one or more additional devices; transmitting the first combined output to the one or more additional devices; and processing the first combined output using a first portion of a second layer of the machine learning network to generate a second output corresponding to the first portion of the second layer.

Aspect 12. The method of Aspect 11, further comprising: transmitting the second output embedding to a first device from the one or more additional devices; receiving, from the first device, a second combined output, wherein the second combined output corresponds to a combination of the second output and a second plurality of output corresponding to additional portions of the second layer of the machine learning network; processing, using a first portion of a third layer of the machine learning network, the second combined output to generate a third output corresponding to the first portion of the third layer of the machine learning network; and determining, based on a combination of the third output and a plurality of outputs corresponding to additional portions of the third layer of the machine learning network, a third combined output.

Aspect 13. The method of any of Aspects 11 to 12, wherein transmissions of the first combined output and the second output are unicast transmissions.

Aspect 14. The method of any of Aspects 11 to 13, further comprising: transmitting the first combined output to each device of the one or more additional devices in a sequential order.

Aspect 15. The method of any of Aspects 11 to 14, wherein the first device receives the first combined output last in the sequential order.

Aspect 16. The method of any of Aspects 11 to 15, wherein each of the one or more additional devices receive the second combined output in the sequential order, and wherein the apparatus receives the second combined output last in the sequential order.

Aspect 17. The method of any of Aspects 11 to 16, wherein the sequential order of transmission of the second combined output is a reverse order of the sequential order of transmission of the first combined output.

Aspect 18. The method of any of Aspects 11 to 17, wherein each device of the one or more additional devices processes an instance of the input embedding.

Aspect 19. The method of any of Aspects 11 to 18, wherein a size of the first portion of the first layer and respective sizes of the additional portions of the first layer are determined based on processing power of the apparatus and processing power of the one or more additional devices.

Aspect 20. The method of any of Aspects 11 to 19, wherein the first layer is a self-attention layer of the machine learning network.

Aspect 21. A non-transitory computer-readable medium having stored thereon instructions that, when executed by at least one processor, cause the at least one processor to perform one or more of operations according to any of Aspects 11 to 20.

Aspect 22. An apparatus for machine learning processing comprising one or more means for performing operations according to any of Aspects 11 to 20.

Aspect 23. An apparatus for machine learning processing, at least one memory; and at least one processor coupled to the at least one memory and configured to: determine to process an input embedding to generate key-value pairs using a pipeline parallelization mode of the apparatus; process the input embedding to generate the key-value pairs based on the pipeline parallelization mode of the apparatus; determine to decode the key-value pairs using a tensor parallelization mode of the apparatus; and generate an output based on the tensor parallelization mode of the apparatus.

Aspect 24. The apparatus of Aspect 23, wherein, to process the input embedding to generate the key-value pairs based on the pipeline parallelization mode of the apparatus, the at least one processor is configured to: partition a machine learning network into a plurality of portions, wherein each portion of the plurality of portions corresponds to one or more layers of the machine learning network, and wherein each portion of the plurality of portions corresponds to a respective device from a first plurality of devices; and process, using a portion of the machine learning network, the input embedding to generate the key-value pairs.

Aspect 25. The apparatus of Aspect 24, wherein, to generate the output based on the tensor parallelization mode of the apparatus, the at least one processor is configured to: process, using a first portion of a first layer of the machine learning network, the key-value pairs to generate a first output corresponding to the first portion of the first layer of the machine learning network; and transmit the first output corresponding to the first portion of the first layer of the machine learning network to a device from a second plurality of devices.

Aspect 26. The apparatus of Aspect 25, wherein, to determine to process the input embedding to generate key-value pairs using the pipeline parallelization mode of the apparatus, the at least one processor is configured to: compare a token latency associated with the pipeline parallelization mode and a token latency associated with the tensor parallelization mode to determine the pipeline parallelization mode is associated with a lower token latency.

Aspect 27. The apparatus of Aspect 26, wherein the token latency of the pipeline parallelization mode and the token latency of the tensor parallelization mode are determined from a look up table (LUT) of token latency values.

Aspect 28. The apparatus of Aspect 27, wherein the second plurality of devices includes a subset of devices from the first plurality of devices or a separate set of devices from the first plurality of devices.

Aspect 29. The apparatus of any of Aspects 27 or 28, wherein the token latency is based on at least one of a data link speed, an input prompt size, a number of devices in the first plurality of devices, or an expected key-value pair size.

Aspect 30. The apparatus of any of Aspects 23 to 29, wherein, to determine to decode the key-value pairs using the tensor parallelization mode, the at least one processor is configured to: compare a decode rate associated with the pipeline parallelization mode and a decode rate associated with the tensor parallelization mode to determine the tensor parallelization mode is associated with a higher decode rate.

Aspect 31. The apparatus of Aspect 30, wherein the decode rate of the pipeline parallelization mode and the decode rate of the tensor parallelization mode are determined from a look up table (LUT) of token latency values.

Aspect 32. The apparatus of any of Aspects 23 to 31, wherein the at least one processor is configured to: transfer the key-value pairs from a first cache associated with a first layer of a machine learning network generated based on the pipeline parallelization mode to a second cache associated with a second layer of the machine learning network to process the key-value pairs based on the tensor parallelization mode.

Aspect 33. The apparatus of Aspect 32, wherein the at least one processor is configured to: process an additional key-value pair in parallel with the transfer.

Aspect 34. A method comprising: determining to process an input embedding to generate key-value pairs using a pipeline parallelization mode of an apparatus; processing the input embedding to generate the key-value pairs based on the pipeline parallelization mode of the apparatus; determining to decode the key-value pairs using a tensor parallelization mode of the apparatus; and generating an output based on the tensor parallelization mode of the apparatus.

Aspect 35. The method of Aspect 34, wherein, to process the input embedding to generate the key-value pairs based on the pipeline parallelization mode of the apparatus, the method further comprising: partitioning a machine learning network into a plurality of portions, wherein each portion of the plurality of portions corresponds to one or more layers of the machine learning network, and wherein each portion of the plurality of portions corresponds to a respective device from a first plurality of devices; and processing, using a portion of the machine learning network, the input embedding to generate the key-value pairs.

Aspect 36. The method of Aspect 35, wherein, to generate the output based on the tensor parallelization mode of the apparatus, the method further comprising: processing, using a first portion of a first layer of the machine learning network, the key-value pairs to generate a first output corresponding to the first portion of the first layer of the machine learning network; and transmitting the first output corresponding to the first portion of the first layer of the machine learning network to a device from a second plurality of devices.

Aspect 37. The method of Aspect 36, wherein, to determine to process the input embedding to generate key-value pairs using the pipeline parallelization mode of the apparatus, the method further comprising: comparing a token latency associated with the pipeline parallelization mode and a token latency associated with the tensor parallelization mode to determine the pipeline parallelization mode is associated with a lower token latency.

Aspect 38. The method of Aspect 37, wherein the token latency of the pipeline parallelization mode and the token latency of the tensor parallelization mode are determined from a look up table (LUT) of token latency values.

Aspect 39. The method of Aspect 38, wherein the second plurality of devices includes a subset of devices from the first plurality of devices or a separate set of devices from the first plurality of devices.

Aspect 40. The method of any of Aspects 38 or 39, wherein the token latency is based on at least one of a data link speed, an input prompt size, a number of devices in the first plurality of devices, or an expected key-value pair size.

Aspect 41. The method of any of Aspects 34 to 40, wherein, to determine to decode the key-value pairs using the tensor parallelization mode, the method further comprising: comparing a decode rate associated with the pipeline parallelization mode and a decode rate associated with the tensor parallelization mode to determine the tensor parallelization mode is associated with a higher decode rate.

Aspect 43. The apparatus of Aspect 41, wherein the decode rate of the pipeline parallelization mode and the decode rate of the tensor parallelization mode are determined from a look up table (LUT) of token latency values.

Aspect 44. The apparatus of any of Aspects 34 to 43, wherein the at least one processor is configured to: transfer the key-value pairs from a first cache associated with a first layer of a machine learning network generated based on the pipeline parallelization mode to a second cache associated with a second layer of the machine learning network to process the key-value pairs based on the tensor parallelization mode.

Aspect 45. The apparatus of Aspect 44, wherein the at least one processor is configured to: process an additional key-value pair in parallel with the transfer.

Aspect 42. A non-transitory computer-readable medium of a computing device having stored thereon instructions that, when executed by at least one processor, cause the at least one processor to perform one or more of operations according to any of Aspects 34 to 45.

Aspect 43. An apparatus for machine learning processing comprising one or more means for performing operations according to any of Aspects 34 to 45.

What is claimed is:

1. An apparatus for machine learning processing,
at least one memory; and
at least one processor coupled to the at least one memory and configured to:
determine to process an input embedding to generate key-value pairs using a pipeline parallelization mode of the apparatus;
process the input embedding to generate the key-value pairs based on the pipeline parallelization mode of the apparatus;
determine to decode the key-value pairs using a tensor parallelization mode of the apparatus; and
generate an output based on the tensor parallelization mode of the apparatus.

2. The apparatus of claim 1, wherein, to process the input embedding to generate the key-value pairs based on the pipeline parallelization mode of the apparatus, the at least one processor is configured to:
partition a machine learning network into a plurality of portions, wherein each portion of the plurality of portions corresponds to one or more layers of the machine learning network, and wherein each portion of the plurality of portions corresponds to a respective device from a first plurality of devices; and
process, using a portion of the machine learning network, the input embedding to generate the key-value pairs.

3. The apparatus of claim 2, wherein, to generate the output based on the tensor parallelization mode of the apparatus, the at least one processor is configured to:
process, using a first portion of a first layer of the machine learning network, the key-value pairs to generate a first output corresponding to the first portion of the first layer of the machine learning network; and
transmit the first output corresponding to the first portion of the first layer of the machine learning network to a device from a second plurality of devices.

4. The apparatus of claim 3, wherein, to determine to process the input embedding to generate key-value pairs using the pipeline parallelization mode of the apparatus, the at least one processor is configured to:
compare a token latency associated with the pipeline parallelization mode and a token latency associated with the tensor parallelization mode to determine the pipeline parallelization mode is associated with a lower token latency.

5. The apparatus of claim 4, wherein the token latency of the pipeline parallelization mode and the token latency of the tensor parallelization mode are determined from a look up table (LUT) of token latency values.

6. The apparatus of claim 5, wherein the second plurality of devices includes a subset of devices from the first plurality of devices or a separate set of devices from the first plurality of devices.

7. The apparatus of claim 5, wherein the token latency is based on at least one of a data link speed, an input prompt size, a number of devices in the first plurality of devices, or an expected key-value pair size.

8. The apparatus of claim 1, wherein, to determine to decode the key-value pairs using the tensor parallelization mode, the at least one processor is configured to:
compare a decode rate associated with the pipeline parallelization mode and a decode rate associated with the tensor parallelization mode to determine the tensor parallelization mode is associated with a higher decode rate.

9. The apparatus of claim 8, wherein the decode rate of the pipeline parallelization mode and the decode rate of the tensor parallelization mode are determined from a look up table (LUT) of token latency values.

10. The apparatus of claim 1, wherein the at least one processor is configured to:
transfer the key-value pairs from a first cache associated with a first layer of a machine learning network generated based on the pipeline parallelization mode to a second cache associated with a second layer of the machine learning network to process the key-value pairs based on the tensor parallelization mode.

11. The apparatus of claim 10, wherein the at least one processor is configured to:
process an additional key-value pair in parallel with the transfer.

12. A method comprising:
determining to process an input embedding to generate key-value pairs using a pipeline parallelization mode of an apparatus;
processing the input embedding to generate the key-value pairs based on the pipeline parallelization mode of the apparatus;
determining to decode the key-value pairs using a tensor parallelization mode of the apparatus; and
generating an output based on the tensor parallelization mode of the apparatus.

13. The method of claim 12, wherein, to process the input embedding to generate the key-value pairs based on the pipeline parallelization mode of the apparatus, the method further comprising:
partitioning a machine learning network into a plurality of portions, wherein each portion of the plurality of portions corresponds to one or more layers of the machine learning network, and wherein each portion of the plurality of portions corresponds to a respective device from a first plurality of devices; and
processing, using a portion of the machine learning network, the input embedding to generate the key-value pairs.

14. The method of claim 13, wherein, to generate the output based on the tensor parallelization mode of the apparatus, the method further comprising:
processing, using a first portion of a first layer of the machine learning network, the key-value pairs to generate a first output corresponding to the first portion of the first layer of the machine learning network; and
transmitting the first output corresponding to the first portion of the first layer of the machine learning network to a device from a second plurality of devices.

15. The method of claim 14, wherein, to determine to process the input embedding to generate key-value pairs using the pipeline parallelization mode of the apparatus, the method further comprising:
comparing a token latency associated with the pipeline parallelization mode and a token latency associated with the tensor parallelization mode to determine the pipeline parallelization mode is associated with a lower token latency.

16. The method of claim 15, wherein the token latency of the pipeline parallelization mode and the token latency of the tensor parallelization mode are determined from a look up table (LUT) of token latency values.

17. The method of claim 16, wherein the second plurality of devices includes a subset of devices from the first plurality of devices or a separate set of devices from the first plurality of devices.

18. The method of claim 16, wherein the token latency is based on at least one of a data link speed, an input prompt size, a number of devices in the first plurality of devices, or an expected key-value pair size.

19. The method of claim 12, wherein, to determine to decode the key-value pairs using the tensor parallelization mode, the method further comprising:
comparing a decode rate associated with the pipeline parallelization mode and a decode rate associated with the tensor parallelization mode to determine the tensor parallelization mode is associated with a higher decode rate.

20. A non-transitory computer-readable medium of a computing device having stored thereon instructions that, when executed by at least one processor, cause the at least one processor to:
determine to process an input embedding to generate key-value pairs using a pipeline parallelization mode of the computing device;
process the input embedding to generate the key-value pairs based on the pipeline parallelization mode of the computing device;
determine to decode the key-value pairs using a tensor parallelization mode of the computing device; and
generate an output based on the tensor parallelization mode of the computing device.
